(19) United States
(12) Patent Application Publication
(10) Pub. No.: US 2016/0299451 A1
(43) Pub. Date: Oct. 13, 2016

(54) CHARGING MEMBER, PROCESS CARTRIDGE, AND ELECTROPHOTOGRAPHIC IMAGE FORMING APPARATUS

(71) Applicant: CANON KABUSHIKI KAISHA, Tokyo (JP)

(72) Inventors: Masataka Kodama, Mishima-shi (JP); Noriyuki Doi, Numazu-shi (JP); Kineo Takeno, Suntou-gun (JP); Noriko Suzumura, Mishima-shi (JP); Hiroki Masu, Tokyo (JP)

(21) Appl. No.: 15/092,479

(22) Filed: Apr. 6, 2016

(30) Foreign Application Priority Data
Apr. 10, 2015 (JP) 2015-081142

(51) Int. Cl. B05C 1/08; G03G 15/02

(52) U.S. Cl. CPC G03G 15/0233

(57) ABSTRACT

Provided is a charging member exhibiting a stable charging performance even by long-term use. The charging member includes a support and a surface layer on the support, and the surface layer contains a magnesium oxide particle, and a compound having a specified structure.

### BACKGROUND

1. Field of the Disclosure

The present disclosure relates to a charging member, a process cartridge using the same, and an electrophotographic image forming apparatus.

2. Description of the Related Art

A charging member which charges an electrophotographic photosensitive member in contact with the charging member generally has a configuration including an elastic layer containing rubber for sufficiently and uniformly securing a contact nip between the electrophotographic photosensitive member and the charging member. In addition, a surface layer is formed on the surface of the elastic layer for the purpose of suppressing bleeding of a low-molecular-weight component contained in the elastic layer and making the charging performance uniform.

Japanese Patent Laid-Open No. 2001-173641 proposes that the surface of an elastic layer is coated with an inorganic oxide film formed by a sol-gel method. Also, Japanese Patent Laid-Open No. 4-77766 proposes that the surface of an elastic layer is coated with a resin layer containing a hydroxystyrene resin.

In recent years, an electrophotographic image forming apparatus has been desired to be further improved in durability. In order to realize this, a charging member has also been desired to exhibit stable charging performance over a long period of time.

The present disclosure is directed to provide a charging member exhibiting stable charging performance even by long-term use.

Also, the present disclosure is directed to provide a process cartridge and an electrophotographic image forming apparatus each contributing to the stable formation of an electrophotographic image of high quality.

### SUMMARY OF THE DISCLOSURE

According to an embodiment of the present disclosure, there is provided a charging member including a support and a surface layer on the support, the surface layer containing a magnesium oxide particle, and a compound represented by a following formula (a):

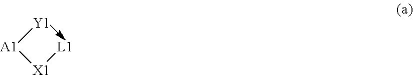

In the formula (a),

L1 represents polymetalloxane having a structural unit represented by M1O_{n/2} wherein when metal atom M1 has a valence of p, n represents an integer of 1 or more and p or less,
M1 represents at least one metal atom selected from the group consisting of Ti, Zr, Hf, V, Nb, Ta, W, Al, Ga, In, and Ge,
X1 represents a structure represented by any one of following formulae (1) to (4),
Y1 represents a group having a site coordinated with M1 in L1, and
(i) when X1 is a structure represented by the formula (1), A1 represents an atomic group necessary for forming a 4- to 8-member ring together with M1, X1, and Y1, and containing an aromatic ring in which a carbon atom constituting the aromatic ring is bonded to an oxygen atom of X1, and
(ii) when X1 is a structure represented by any one of the formulae (2) to (4),
A1 represents a bond or atomic group necessary for forming a 4- to 8-member ring together with M1, X1, and Y1.

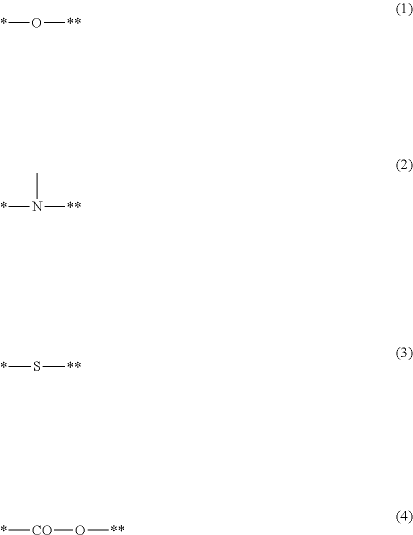

In the formulae (1) to (4), symbol “*” represents a bonding site with A1, and symbol “**” represents a bonding site with M1 in L1.

According to another embodiment of the present disclosure, there is provided a charging member including a support and a surface layer on the support, the surface layer containing a magnesium oxide particle, and a compound represented by a following formula (b):

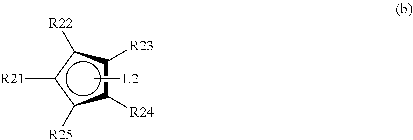

In the formula (b),

L2 represents polymetalloxane having a structural unit represented by M2O_{m/2} wherein M2 represents at least one metal atom selected from the group consisting of Ti, Zr, Hf, V, Nb, Ta, W, Al, Ga, In, and Ge, and
when metal atom M2 has a valence of q, m represents an integer of 1 or more and q or less,
R21 to R25 each independently represent a hydrogen atom, an alkyl group having 1 to 4 carbon atoms, or a trimethylsilyl group, and
a cyclopentadienyl group is coordinated with the metal atom M2 in L2.

According to a further embodiment of the present disclosure, there is provided a charging member including a support and a surface layer on the support, the surface layer containing a magnesium oxide particle and a polymetalloxane represented by a following formula (c1):

In the polymetalloxane, M3 is bonded to a carbon atom in a structural unit represented by a following structural formula (c2) with a linking group represented by a following structural formula (c3):

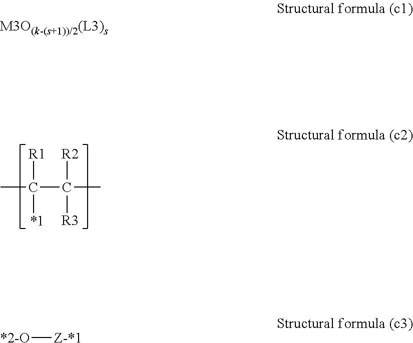

In the formula (c1),

M3 represents any one of metal atoms of Ti, Zr, Hf, V, Nb, Ta, W, Al, Ga, In, and Ge, s represents an integer of 0 or more and k or less,
when M3 is A1, Ga, or In, k=3,
when M3 is Ti, Zr, Hf, or Ge, k=4,
when M3 is Nb, Ta, or W, k=5,
when M3 is V, k=3 or 5, and
L3 represents a ligand having a structure represented by formula (d) below or a ligand having a structure represented by formula (e) below.

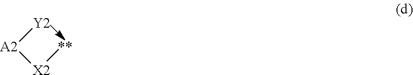

In the formula (d),

X2 represents a structure represented by any one of following formulae (5) to (8),
Y2 represents a group having a site coordinated with M3,
A2 represents a bond or atomic group necessary for forming a 4- to 8-member ring together with M3, X2, and Y2, and symbol “**” represents a site bonded or coordinated with M3.

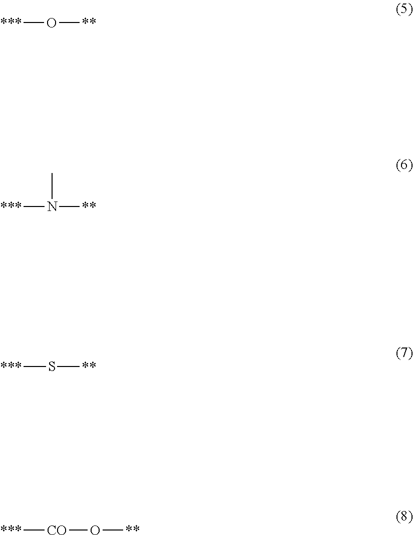

In the formulae (5) to (8), symbol “**” represents a bonding site with M3, and symbol “***” represents a bonding site with A2.

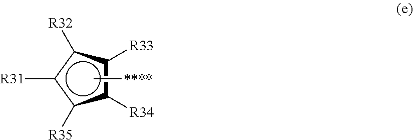

In the formula (e), R31 to R35 each independently represent a hydrogen atom, an alkyl group having 1 to 4 carbon atoms, or a trimethylsilyl group, and symbol “****” represents a bonding site with M3.

In the formula (c2), R1 to R3 each independently represent a hydrogen atom or an alkyl group having 1 to 3 carbon atoms, and symbol “*1” represents a bonding site with Z in formula (a3).

In the formula (c3),

Z represents a substituted or unsubstituted phenylene group, and in the case of a substituted phenylene group, a substituent is a halogen atom or an alkyl group having 1 to 3 carbon atoms,
symbol “*1” represents a bonding site with the symbol “*1” in the formula (c2), and
symbol “*2” represents a bonding site with M3 in the formula (c1).

According to a further embodiment of the present disclosure, there is provided a process cartridge detachable from an electrophotographic image forming apparatus body and including an electrophotographic photosensitive member and a charging member which charges the surface of the electrophotographic photosensitive member, both members being integrally supported. The charging member is any one of the charging members described above.

According to a further embodiment of the present disclosure, there is provided an electrophotographic image forming apparatus including an electrophotographic photosensitive member and a charging member which charges the surface of the electrophotographic photosensitive member. The charging member is any one of the charging members described above.

Further features of the present disclosure will become apparent from the following description of exemplary embodiments with reference to the attached drawings.

### BRIEF DESCRIPTION OF THE DRAWINGS

FIG. 1 is a sectional view of a charging member according to an embodiment of the present disclosure.

FIG. 2 is a schematic view of an example of an electrophotographic image forming apparatus according to an embodiment of the present disclosure.

FIG. 3 is a schematic explanatory drawing of a method for measuring charging polarity of a surface layer according to an embodiment of the present disclosure.

FIG. 4 is a ¹H-NMR chart of an example of polytitanoxane according to an embodiment of the present disclosure.

FIG. 5 is a solid-state NMR chart of an example of polytitanoxane according to an embodiment of the present disclosure.

FIG. 6 is a schematic view of an example of a process cartridge according to an embodiment of the present disclosure.

### DESCRIPTION OF THE EMBODIMENTS

A conceivable cause of change with time in charging performance of a charging member is the adhesion of a toner and external additives.

Japanese Patent Laid-Open No. 2007-004102 describes, as a charging member causing little adhesion of a toner and external additives to the surface thereof even by long-term repeated use, a charging member including a surface layer containing polysiloxane which has a fluoroalkyl group and an oxyalkylene group. Also, Japanese Patent Laid-Open No. 2009-58635 describes that a charging member including a surface layer containing polysiloxane and silicone oil suppresses the adhesion of a toner and external additives.

According to the research performed by the inventors, in an electrophotographic process using a negatively chargeable toner, the toner (hereinafter referred to as the “transfer residual toner”) remaining on an electrophotographic photosensitive member and untransfered to a recording medium contains the toner with weak negative charge or positive charge. When being in contact with a charging member, the weakly negatively charged or positively charged toner may adhere to the surface of the charging member by electrostatic attraction.

The inventors confirmed that the charging members described in Japanese Patent Laid-Open Nos. 2007-004102 and 2009-58635 securely suppress the adhesion of the toner to the surface of the charging member, but in order to further improve stability with time of the charging performance, it is necessary to suppress the amount of the toner electrostatically adhering to the surface of the charging member.

Therefore, the inventors repeated research. As a result, it was found that a film containing a compound having a specified structure and magnesium oxide particles has the high ability of negatively charging a negatively chargeable toner by friction with the negatively chargeable toner. It was also found that a charging member including a surface layer made of the film can very effectively suppress the toner adhesion to the surface and more stably maintain charging performance.

A charging member according to an embodiment of the present disclosure is described below.

### [Charging Member]

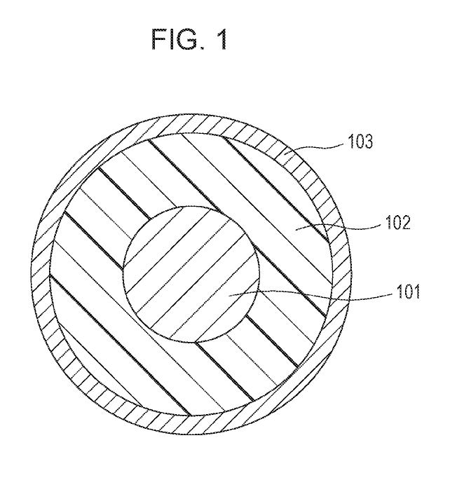

FIG. 1 shows a section of a roller-shaped charging member according to an embodiment of the present disclosure. The charging member includes a support 101, a conductive elastic, and a surface layer 103. The shape of the charging member is not limited to a roller shape and may be any desired shape.

The charging member disposed to enable charging of the surface of an electrophotographic photosensitive member (also referred to as a “photosensitive member” hereinafter) can include an elastic layer for satisfactorily securing a contact nip with the photosensitive member. The simplest configuration of the charging member including the elastic layer has two layers provided on a support and including an elastic layer and a surface layer. In addition, one or two or more other layers may be provided between the support and the elastic layer or between the elastic layer and the surface layer.

### [Support]

A support having conductivity is used as the support 101. Examples thereof include metal-made (alloy-made) supports made of iron, copper, stainless steel, aluminum, an aluminum alloy, and nickel.

### [Elastic Layer]

One or two or more elastic materials such as rubber, thermoplastic elastomer, and the like, which have been used for an elastic layer of a charging member, can be used as a material constituting the elastic layer 102.

Examples of the rubber include urethane rubber, silicone rubber, butadiene rubber, isoprene rubber, chloroprene rubber, styrene-butadiene rubber, ethylene-propylene rubber, polynorbornene rubber, acrylonitrile rubber, epichlorohydrin rubber, alkyl ether rubber, and the like. Examples of the thermoplastic elastomer include styrene-based elastomers, olefin-based elastomers, and the like.

The elastic layer 102 can be configured to contain a conductive agent so as to have predetermined conductivity. The electric resistance value of the elastic layer 102 is within a range of 10²Ω or more and 10⁸Ω or less.

Examples of the conductive agent which can be used in the elastic layer 102 include carbon-based materials, metal oxides, metals, cationic surfactants, anionic surfactants, amphoteric surfactants, antistatic agents, electrolytes, and the like.

Examples of the carbon-based materials include conductive carbon black, graphite, and the like. Examples of the metal oxides include tin oxide, titanium oxide, zinc oxide, and the like. Examples of the metals include nickel, copper, silver, germanium, and the like.

Examples of the cationic surfactants include quaternary ammonium salts (lauryl trimethyl ammonium, stearyl trimethyl ammonium, octadodecyl trimethyl ammonium, dodecyl trimethyl ammonium, hexadecyl trimethyl ammonium, modified fatty acid-dimethyl ethyl ammonium, and the like), perchlorates, chlorates, fluoroborate salts, ethosulfate salts, halogenated benzyl salts (such as benzyl bromide salts, benzyl chloride salts, and the like), and the like.

Examples of the anionic surfactants include aliphatic sulfonic acid salts, higher-alcohol sulfuric acid ester salts, higher-alcohol ethylene oxide-added sulfuric acid ester salts, higher-alcohol phosphoric acid ester salts, and higher-alcohol ethylene oxide-added phosphoric acid ester salts.

Examples of the antistatic agents include nonionic antistatic agents such as higher-alcohol ethylene oxide, polyethylene glycol fatty acid esters, polyhydric alcohol fatty acid esters, and the like.

Examples of the electrolytes include salts (quaternary ammonium salts and the like) of periodic table Group I metals (such as Li, Na, K, and the like) and the like. Examples of the salts of periodic table Group I metals include LiCF₃SO₃, NaClO₄, LiAsF₆, LiBF₄, NaSCN, KSCN, and NaCl.

Also, a salt (Ca(ClO₄)₂ or the like) of a periodic table group II metal (such as Ca, Ba, or the like) or an antistatic agent induced from the salt can be used as the conductive agent for the elastic layer 102. Further, an ionic conductive agent such as a complex of the metal with a polyhydric alcohol (such as 1,4-dutanediol, ethylene glycol, polyethylene glycol, propylene glycol, or polypropylene glycol) or a derivative thereof or a complex with monool (ethylene glycol monomethyl ether or ethylene glycol monoethyl ether) can also be used.

The hardness of the elastic layer 102 is 60 degrees or ore and 85 degrees or less in terms of MD-1 hardness from the viewpoint of suppressing deformation of the charging member when the charging member is brought into contact with the photosensitive member as a charged body. Also, the elastic layer 102 has a so-called crown shape in which the thickness of a central portion is larger than that at the ends in order to achieve uniform contact with the photosensitive member in the width direction.

### Surface Layer

### (i) First Embodiment

The surface layer 103 of the charging member contains a compound represented by formula (a) below and magnesium oxide particles.

### (Compound Represented by Formula (a))

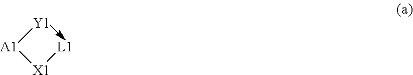

In the formula (a),

L1 represents polymetalloxane having a structural unit represented by M1O_{n/2} wherein when metal atom M1 has valence
p, n represents an integer of 1 or more and p or less,
M1 represents at least one metal atom selected from the group consisting of Ti, Zr, Hf, V, Nb, Ta, W, Al, Ga, In, and Ge,
X1 represents a structure represented by any one of formulae (1) to (4) below,
Y1 represents a group having a site coordinated with M1 in L1, and
(i) when X1 is a structure represented by the formula (1), A1 represents an atomic group necessary for forming a 4- to 8-member ring together with M1, X1, and Y1, and containing an aromatic ring in which a carbon atom constituting the aromatic ring is bonded to an oxygen atom of X1, and
(ii) when X1 is a structure represented by any one of the formulae (2) to (4),
A1 represents a bond or atomic group necessary for forming a 4- to 8-member ring together with M1, X1, and Y1.

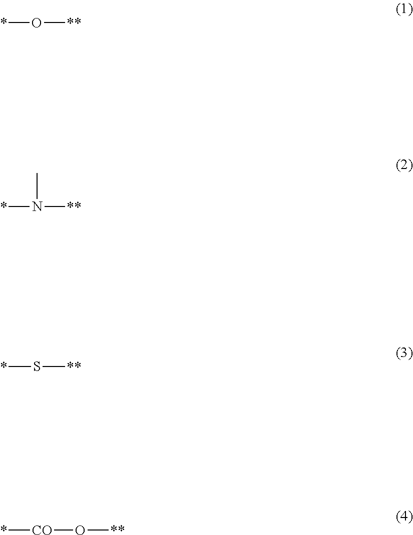

In the formulae (1) to (4), symbol “*” represents a bonding site with A1, and symbol “**” represents a bonding site with M1 in L1.

The metal atom M1 in polymetalloxane may contain a plurality of types of metal atoms. Also, the polymetalloxane may have a structural unit represented by SiO_{r/2} (r is an integer of 1 or more and 4 or less). Having the structural unit can improve amorphousness of polymetalloxane and further improve the smoothness and strength of a film.

In the formula (2), a nitrogen atom may be a nitrogen atom in a heterocycle such as a pyrrole skeleton, an indole skeleton, a pyrrolidine skeleton, a carbazole skeleton, an imidazole skeleton, a benzoimidazole skeleton, a pyrrazole skeleton, an indazole skeleton, a triazole skeleton, a benzotriazole skeleton, a tatrazole skeleton, a pyrrolidone skeleton, a piperidine skeleton, a morpholine skeleton, a piperazine skeleton, or the like. These skeletons may have a substituent. The substituent may be a straight or branched alkyl group or alkoxy group having 1 to 10 carbon atoms and more preferably 1 to 4 carbon atoms (the same is true for substituents described below unless otherwise specified.) When the nitrogen atom is not a nitrogen atom in a heterocycle, an atom or group other than A1 and M1 bonded to the nitrogen atom is a hydrogen atom, a substituted or unsubstituted aryl group, or an alkyl group having 1 to 10 carbon atoms. Examples thereof include aryl groups such as a phenyl group, a naphthyl group, and the like, linear alkyl groups such as a methyl group, an ethyl group, a n-propyl group, a n-butyl group, a n-hexyl group, a n-octyl group, a n-decyl group, and the like, branched alkyl groups such as an isopropyl group, a tert-butyl group, and the like, cyclic alkyl groups such as a cyclopentyl group, a cyclohexyl group, and the like. In particular, a group represented by the formula (2) may be a group in which a hydrogen atom bonded to a nitrogen atom is removed from an unsubstituted amino group, a monoalkylamino group having 1 to 4 carbon atoms, or a group having a pyrrole skeleton.

Y1 in the formula (a) represents a group which has a site coordinated with M1 in L1 and which contains an atom having an unshared electron pair. Examples thereof include a hydroxyl group, an alkoxy group, an aryloxy group, a carbonyl group, an alkylthio group, an arylthio group, a thiocarbonyl group, a substituted or unsubstituted amino group, a substituted or unsubstituted imino group, and the like.

The alkoxy group is, for example, a straight or branched alkoxy group having 1 to 10 carbon atoms. Examples thereof include a methoxy group an ethoxy group, a n-propoxy group, an isopropoxy group, a n-butoxy group, and a tert-butoxy group. An alkoxy group having 1 to 4 carbon atoms is preferred.

Examples of the aryloxy group include a phenoxy group and a naphthyloxy group. These group may have a substituent.

An example of the alkylthio group is a group in which an oxygen atom of an alkoxy group is substituted with a sulfur atom.

An example of the arylthio group is a group in which an oxygen atom of an aryloxy group is substituted with a sulfur atom.

Examples of the carbonyl group include a formyl group, an alkylcarbonyl group, an alkoxycarbonyl group, an arylcarbonyl group, an amide group (R—CO—NR— or —R—NR—CO—), a ureido group (NH₂—CO—NH—), and a urea group (R—NH—CO—NH—). Each of alkyl groups of an alkylcarbonyl group and alkoxycarbonyl group and R in an amide group and a urea group is preferably a straight or branched alkyl group having 1 to 10 carbon atoms. Examples of an alkyl group include straight alkyl groups such as a methyl group, an ethyl group, a n-propyl group, a tert-butyl group, a hexyl group, a n-octyl group, a n-nonyl group, and a n-decyl group, and branched alkyl groups such as an isopropyl group and a tert-butyl group. An alkyl group having 1 to 4 carbon atoms is more preferred.

The arylcarbonyl group is, for example, a group having a carbonyl group bonded to a substituted or unsubstituted aromatic hydrocarbon or a group having a carbonyl group bonded to a substituted or unsubstituted aromatic heterocycle. Examples thereof include substituted or unsubstituted phenylcarbonyl group and naphthylcarbonyl group.

The thiocarbonyl group is, for example, a group in which an oxygen atom in the carbonyl group is substituted with a sulfur atom.

The substituted amino group is, for example, an alkylamino group, a dialkylamino group, or a substituted or unsubstituted arylamino group. Examples thereof include monoalkylamino groups having 1 to 10 carbon atoms such as a monomethylamino group, a monoethylamino group, and the like, dialkylamino group having 1 to 10 carbon atoms such as a dimethylamino group, a diethylamino group, an ethylmethylamino group, and the like, and substituted or unsubstituted arylamino groups such as a monophenylamino group, a methylphenylamino group, a diphenylamino group, a naphthylamino group, and the like.

The unsubstituted imino group is a group represented by >C═NH or —N═CH₂. A hydrogen atom in the unsubstituted imino group may be substituted with an alkyl group having 1 to 10 carbon atoms or a substituted or unsubstituted aryl group (a phenyl group or naphthyl group).

Also, Y1 may be a group having an aliphatic or aromatic heterocyclic skeleton. Examples of an aromatic heterocyclic skeleton include a thiophene skeleton, a furan skeleton, a pyridine skeleton, a pyran skeleton, a benzothiophene skeleton, a benzofuran skeleton, a quinoline skeleton, an isoquinoline skeleton, an oxazole skeleton, a benzoxazole skeleton, a thiazole skeleton, a benzothiazole skeleton, a thiadiazole skeleton, a benzothiadiazole skeleton, a pyridazine skeleton, a pyrimidine skeleton, a pyrazine skeleton, a phenazine skeleton, an acridine skeleton, a xanthene skeleton, an imidazole skeleton, a benzoimidazole skeleton, a pyrazole skeleton, an indazole skeleton, a triazole skeleton, a benzotriazole skeleton, and a tetrazole skeleton. These skeletons may have a substitute. An example of an aliphatic heterocyclic skeleton is a substituted or unsubstituted morpholine skeleton.

Among the groups Y1 described above, Y1 is preferably a hydroxyl group, an alkoxy group having 1 to 4 carbon atoms, a substituted or unsubstituted phenoxy group, a substituted or unsubstituted naphthyloxy group, a formyl group, an alklycarbonyl group containing an alkyl group having 1 to 4 carbon atoms, an alkoxycarbonyl group containing an alkoxy group having 1 to 4 carbon atoms, a thiocarbonyl group, a dimethylamide group, a diethylamide group, an ethylmethylamide group, an unsubstituted amino group, a monomethylamino group, a monoethylamino group, a dimethylamino group, a diethylamino group, a monophenylamino group, a methylethylamino group, a methylphenylamino group, a diphenylamino group, a naphthylamino group, an unsubstituted imino group, a methaneimino group, an ethaneimino group, a group having a pyridine skeleton, a group having a quinoline skeleton, or a group having an isoquinoline skeleton.

When X1 is the formula (1), A1 in the formula (a) is an atomic group necessary for forming a 4- to 8-member ring together with M1, X1, and Y1 and contains an aromatic ring in which a carbon atom constituting the aromatic ring is bonded to an oxygen atom of X1.

Examples of A1 include atomic groups each containing a substituted or unsubstituted aromatic ring (a benzene ring, a naphthalene ring, a pyrrole ring, a thiophene ring, a furan ring, a pyridine ring, an indole ring a benzothiophene ring, a benzofuran ring, a quinoline ring, or an isoquinoline ring). Also, A1 may form a condensed ring with an aromatic heterocyclic ring of Y1. A1 is particularly preferably an atomic group containing an aromatic ring (a benzene ring or a naphthalene ring).

When X1 is the formula (1), it is important for A1 to have an aromatic ring. When A1 has an aromatic ring, a metal complex having a structure formed by A1, M1, X1, and Y1 has higher stability, and thus the charging member has higher performance stability.

When X1 is a structure represented by any one of the formulae (2) to (4), A1 in the formula (a) represents a bond or atomic group necessary for forming a 4- to 8-member ring together with M1, X1, and Y1. When A1 is an atomic group necessary for forming a 4- to 8-member ring together with M1, X1, and Y1, examples of the atomic group include atomic groups each containing an alkylene group, such as a methylene group, an ethylene group, or the like, or an aromatic ring (a benzene ring, a naphthalene ring, a pyrrole ring, a thiophene ring, a furan ring, a pyridine ring, an indole ring, a benzothiophene ring, a benzofuran ring, a quinoline ring, an isoquinoline ring, or the like).

A1 is particularly preferably a bond or an atomic group containing an alkylene group or an aromatic ring (a benzene ring or a naphthalene ring).

When A1 is an atomic group containing an aromatic ring, a condensed ring may be formed together with an aromatic heterocyclic ring of Y1, an aromatic heterocyclic ring of X1, or both aromatic heterocyclic rings.

In the formula (a), a ring formed by A1, M1, X1, and Y1 is preferably a 5- or 6-member ring from the viewpoint of the ease of formation of a complex.

Preferred combinations of A1, X1, and Y1 in the formula (a) include two combinations below.

A1 is a structure represented by formula (A1-1) or (A1-2) below, X1 is a structure represented by formula (X1-1) or (X1-2) below, and Y1 is a methoxy group, an ethoxy group, a formyl group, a methylcarbonyl group, a ethylcarbonyl group, a methoxycarbonyl group, an ethoxycarbonyl group, a dimethylamide group, a diethylamide group, a methylethylamide group, a methylthio group, an ethylthio group, a thiocarbonyl group, a dimethylamino group, a diethylamino group, an ethylmethylamino group, an unsubstituted imino group, a methaneimino group, an ethaneimino group, a group having a pyridine skeleton, a group having a quinoline skeleton, or a group having an isoquinoline skeleton.

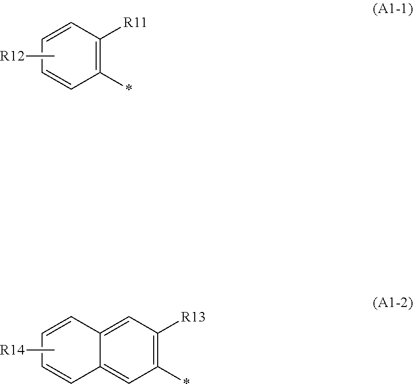

In the formulae (A1-i) and (A1-2), R11 and R13 each independently represent a single bond or methylene group bonded to Y1, R12 and R14 each independently represent a hydrogen atom, a methoxy group, or an ethoxy group, and symbol “*” represents a bonding site with X1.

*—O—** (X1-1)

*—CO—O—** (X1-2)

In the formulae (X1-l) and (X1-2), symbol “*” represents a bonding site with A1, and symbol “**” represents a bonding site with M1.

In the combination described above, when Y1 is a group having a pyridine skeleton, a group having a quinoline skeleton, or a group having an isoquinoline skeleton, an aromatic ring in Y1 may form a condensed ring with an aromatic ring in A1.

In addition, A1 is a bond, a methylene group, an ethylene group, or a trimethylene group, X1 is a structure represented by any one of formulae (X1-3) to (X1-7), and Y1 is a methoxy group, an ethoxy group, a formyl group, a methylcarbonyl group, an ethylcarbonyl group, a methoxycarbonyl group, an ethoxycarbonyl group, a dimethylamide group, a diethylamide group, a methylethylamide group, a methylthio group, an ethylthio group, a thiocarbonyl group, a dimethylamino group, a diethylamino group, an ethylmethylamino group, an unsubstituted imino group, a methaneimino group, an ethaneimino group, a group having a pyridine skeleton, a group having a quinoline skeleton, or a group having an isoquinoline skeleton.

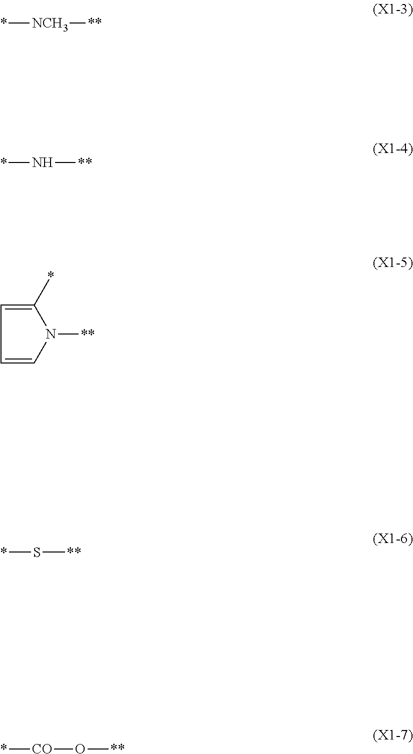

In the formulae (X1-3) to (X1-7), symbol “*” represents a bonding site with A1, and symbol “**” represents a bonding site with M1.

In the two combinations of A1, X1, and Y1 described above, further a ring formed by A1, M1, X1, and Y1 is preferably a 5- or 6-member ring from the viewpoint of the ease of formation of a complex.

In the formula (a), examples of a compound (hereinafter referred to as a “compound for a ligand”) which is coordinated and bonded to a metal atom to form the above-described structure are summarized in Tables 1 to 4. In Tables 1 to 4, “Me” represents a methyl group.

Some of the compounds for a ligand shown in Tables 1 to 4 are described in detail below.

When X1 is the formula (1), an example of the compound for a ligand is guaiacol represented by formula (101) below.

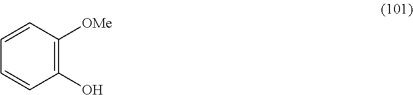

Guaiacol forms a complex in which a hydrogen atom of a hydroxyl group in guaiacol is removed, an oxygen atom is bonded to a metal atom, and an oxygen atom of a methoxy group is coordinated with the metal atom. The residual 1,2-phenylene group corresponds to A1.

When X1 is the formula (1), another example of the compound for a ligand is 4-hydroxy-5-azaphenanthrene represented by formula (102) below. 4-Hydroxy-5-azaphenanthrene is a compound for a ligand in which an aromatic ring in A1 is integrated with an aromatic heterocycle of Y1.

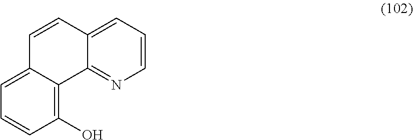 [SMILES: Oc1cccc2ccc3cccnc3c12]

4-Hydroxy-5-azaphenanthrene forms a complex in which a hydrogen atom of a hydroxyl group is removed, an oxygen atom is bonded to a metal atom, and a nitrogen atom of a pyridine skeleton is coordinated with the metal atom. The naphthalene skeleton corresponds to A1, and the pyridine skeleton and the naphthalene skeleton form a condensed ring, thereby forming an azaphenanthrene skeleton.

When X1 is any one of the formulae (2) to (4), an example of the compound for a ligand is 2-acetylpyrrole represented by formula (103) below.

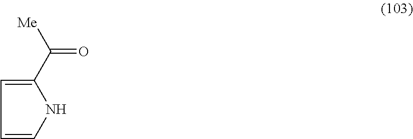

2-Acetylpyrrole forms a complex in which a nitrogen atom of a pyrrole skeleton is bonded to a metal atom, and an oxygen atom of an acetyl group is coordinated with the metal atom. A bond between the acetyl group and the pyrrole group corresponds to A1.

TABLE 1

| | Y1 and Y2 | | | | | | |
|---|---|---|---|---|---|---|---|
| | Hydroxyl group | | | | | | |
| | Alkoxy group | | | | | Alkylthio group | Thiocarbonyl |
| X1 and X2 | Aryloxy group | Carbonyl group | | | | Arylthio group | group |
| *—O—** | 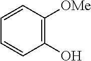 | | | | | 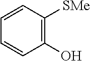 | |
| 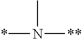 | 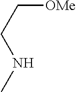 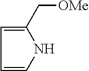 | 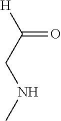 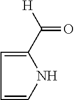 | 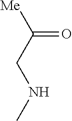 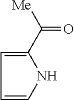 | 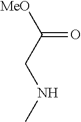 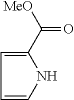 | 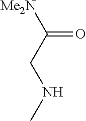 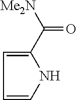 | 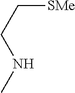 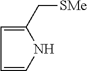 | 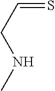 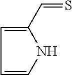 |
| *—S—** | 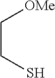 | 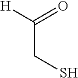 | 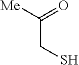 | 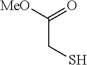 | 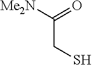 | 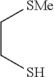 | 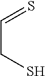 |
| *—CO—O—** | 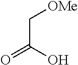 | 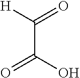 | 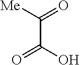 | 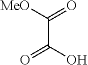 | 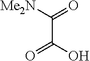 | 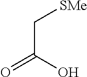 | 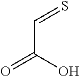 |

| | Y1 and Y2 | | | | | |
|---|---|---|---|---|---|---|
| X1 and X2 | Amino group | Imino group | | Heterocycle | | |
| *—O—** | 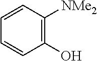 | | 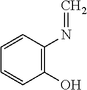 | 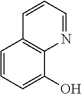 [SMILES: Oc1cccc2cccnc12] | | |
| 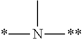 | 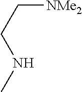 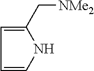 | 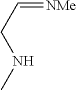 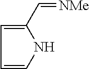 | 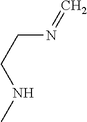 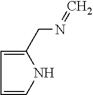 | 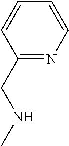 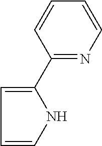 [SMILES: c1ccc(-c2ccc[nH]2)nc1] | 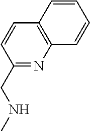 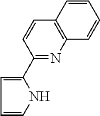 [SMILES: c1c[nH]c(-c2ccc3ccccc3n2)c1] | 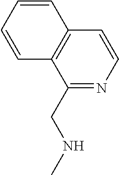 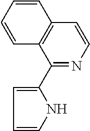 [SMILES: c1c[nH]c(-c2nccc3ccccc23)c1] |
| *—S—** | 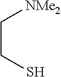 | 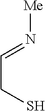 | 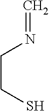 | 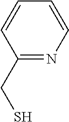 | 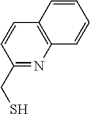 [SMILES: SCc1ccc2ccccc2n1] | 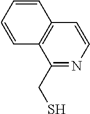 [SMILES: SCc1nccc2ccccc12] |
| *—CO—O—** | 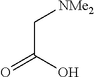 | 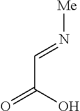 | 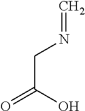 | 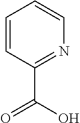 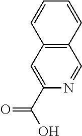 [SMILES: O=C(O)c1cc2ccccc2cn1] | 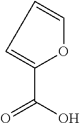 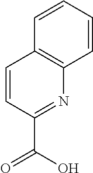 [SMILES: O=C(O)c1ccc2ccccc2n1] | 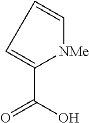 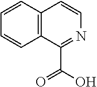 [SMILES: O=C(O)c1nccc2ccccc12] |

TABLE 3

| | Y1 and Y2 | | | | | | |
|---|---|---|---|---|---|---|---|
| | Hydroxyl group | | | | | | |
| | Alkoxy group | | | | | Alkylthio group | Thiocarbonyl |
| X1 and X2 | Aryloxy group | Carbonyl group | | | | Arylthio group | group |
| *—O—** | 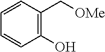 | 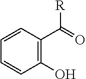 | 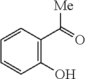 | 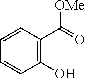 [SMILES: COC(=O)c1ccccc1O] | 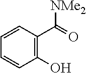 [SMILES: CN(C)C(=O)c1ccccc1O] | 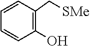 | 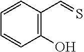 |
| 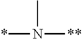 | 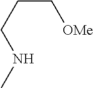 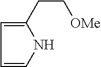 | 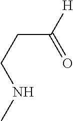 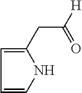 | 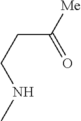 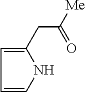 | 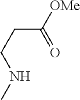 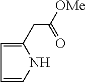 | 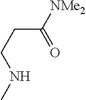 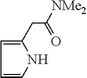 [SMILES: CN(C)C(=O)Cc1ccc[nH]1] | 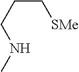 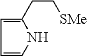 | 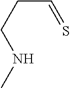 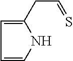 |
| *—S—** | 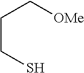 | 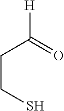 | 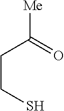 | 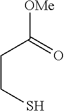 | 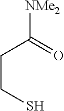 | 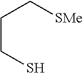 | 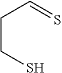 |
| *—CO—O—** | 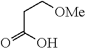 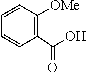 [SMILES: COc1ccccc1C(=O)O] | 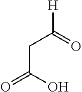 | 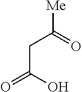 | 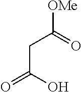 | 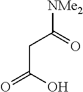 | 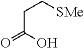 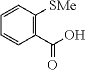 [SMILES: CSc1ccccc1C(=O)O] | 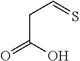 |

TABLE 4

| | Y1 and Y2 | | | | |
|---|---|---|---|---|---|
| X1 and X2 | Amino group | Imino group | | Heterocycle | |
| *—O—** | 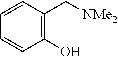 [SMILES: CN(C)Cc1ccccc1O] | 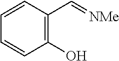 | 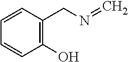 | 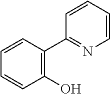 [SMILES: Oc1ccccc1-c1ccccn1] | 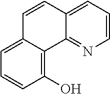 [SMILES: Oc1cccc2ccc3cccnc3c12] |
| 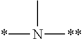 | 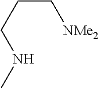 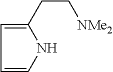 | 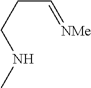 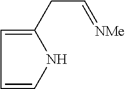 | 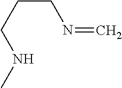 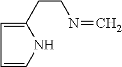 | 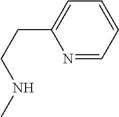 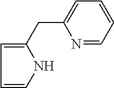 [SMILES: c1ccc(Cc2ccc[nH]2)nc1] | 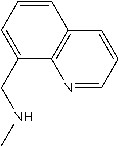 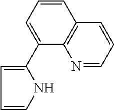 [SMILES: c1c[nH]c(-c2cccc3cccnc23)c1] |
| *—S—** | 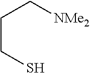 | 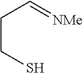 | 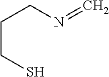 | 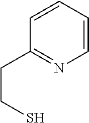 | 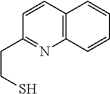 [SMILES: SCCc1ccc2ccccc2n1] |
| *—CO—O—** | 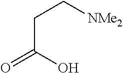 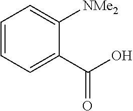 [SMILES: CN(C)c1ccccc1C(=O)O] | 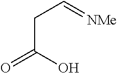 | 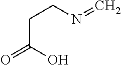 | 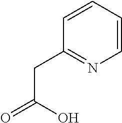 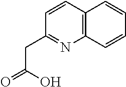 [SMILES: O=C(O)Cc1ccc2ccccc2n1] | 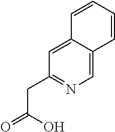 [SMILES: O=C(O)Cc1cc2ccccc2cn1] 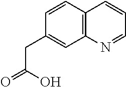 [SMILES: O=C(O)Cc1ccc2cccnc2c1] |

### <Magnesium Oxide Particle>

Known magnesium oxide particles can be used as the magnesium oxide particles. The average particle diameter of primary particles of the magnesium oxide particles is preferably within a range of 0.05 μm or more and 10 μm or less. From the viewpoint of coating properties and dispersion stability of magnesium oxide in a coating solution, the average particle diameter of primary particles of the magnesium oxide particles is particularly preferably within a range of 0.05 μm or more and 3 μm or less. From the viewpoint of stability of a coating solution, high-purity magnesium oxide having a low moisture content is preferably used, and thus magnesium oxide with a purity of 99.9% or more is preferably used. Examples of the magnesium oxide include trade name “500A” (particle diameter: 45 to 60 nm) and trade name “2000A” (particle diameter: 190 to 240 nm) which are “(vapor phase method) high-purity ultrafine magnesia powder” manufactured by Ube Material Industries Co., Ltd.

### (Method for Forming Surface Layer)

The surface layer 103 can be formed on the support 101 or the elastic layer 102 by drying a coating film of a coating solution.

The coating solution can be prepared by mixing a metal alkoxide, a compound for a ligand, and magnesium oxide in an organic solvent. When available, a metal alkoxide with which a compound is coordinated can be obtained and directly used.

Examples of the metal alkoxide include alkoxides of titanium, zirconium, hafnium, vanadium, niobium, tantalum, tungsten, aluminum, gallium, indium, and germanium. Examples of the alkoxide include methoxide, ethoxide, n-propoxide, iso-propoxide, n-butoxide, 2-butoxide, and tert-butoxide.

The compound for a ligand is preferably added in an amount of 0.5 mole or more, more preferably 1 mole or more, based on 1 mole of the metal alkoxide. In addition, a plurality of compounds or metal alkoxides may be combined.

In the compound represented by the formula (a), a bond between the metal atom and the compound for a ligand can be confirmed by performing ¹H-NMR analysis.

In order to form polymetalloxane by condensation the metal alkoxide, if required, water, an acid, or a base can be added as a catalyst to the coating solution. Also, condensation may be accelerated by heating the coating solution. When water is added, the amount of water added is preferably 0.01 moles to 5 moles and more preferably 0.1 moles to 3 moles based on 1 mole of the metal alkoxide.

In order to improve the film properties (smoothness and strength of the film) of the surface layer 103, alkoxysilane can be added to the coating solution. Examples of the alkoxysilane which can be used include tetraalkoxysilane, trialkoxysilane, and dialkoxysilane.

Examples of the tetraalkoxysilane include tetramethoxysilane, tetraethoxysilane, tetra(n-propoxy)silane, tetra(iso-propoxy)silane, tetra(n-butoxy)silane, tetra(2-butoxy)silane, and tetra(tert-butoxy)silane.

Examples of the trialkoxysilane include trimethoxysilanes such as trimethoxyhydrosilane, trimethoxymethylsilane, trimethoxyethylsilane, trimethoxy(n-propyl)silane, trimethoxy(iso-propoxy)silane, trimethoxy(n-butoxy)silane, trimethoxy(2-butoxy)silane, trimethoxy(tert-butoxy)silane, trimethoxy(n-hexyl)silane, trimethoxy(n-octyl)silane, trimethoxy(n-decyl)silane, trimethoxy(n-dodeca)silane, trimethoxy(n-tetradeca)silane, trimethoxy(n-pentadeca)silane, trimethoxy(n-hexadeca)silane, trimethoxy(n-octadeca)silane, trimethoxycyclohexylsilane, trimethoxyphenylsilane, trimethoxy(3-glycidylpropyl)silane, and the like, and triethoxysilanes such as triethoxyhydrosilane, triethoxymethylsilane, triethoxyethylsilane, triethoxy(n-propyl)silane, triethoxy(iso-propoxy)silane, triethoxy(n-butoxy)silane, triethoxy(2-butoxy)silane, triethoxy(tert-butoxy)silane, triethoxy(n-hexyl)silane, triethoxy(n-octyl)silane, triethoxy(n-decyl)silane, triethoxy(n-dodeca)silane, triethoxy(n-tetradeca)silane, triethoxy(n-pentadeca)silane, triethoxy(n-hexadeca)silane, triethoxy(n-octadeca)silane, triethoxycyclohexylsilane, triethoxyphenylsilane, triethoxy(3-glycidylpropyl)silane, and the like.

Examples of the dialkoxysilane include dimethoxysilanes such as dimethoxydimethylsilane, dimethoxydiethylsilane, dimethoxymethylphenylsilane, dimethoxydiphenylsilane, dimethoxy(bis-3-glycidylpropyl)silane, and the like, and diethoxysilanes such as diethoxydimethylsilane, diethoxydiethylsilane, diethoxymethylphenylsilane, diethoxydiphenylsilane, diethoxy(bis-3-glycidylpropyl)silane, and the like.

The organic solvent used is not particularly limited as long as the metal alkoxide and the compound can be dissolved, but an alcohol solvent, an ether solvent, a cellosolve solvent, a ketone solvent, an ester solvent, and the like can be used. Examples of the alcohol solvent include methanol, ethanol, n-propanol, isopropanol, 1-butanol, 2-butanol, tert-butanol, 1-pentanol, and cyclohexanol. Examples of the ether solvent include dimethoxyethane. Examples of the cellosolve solvent include methyl cellosolve and ethyl cellosolve. Examples of the ketone solvent include acetone, methyl ethyl ketone, and methyl iso-butyl ketone. Examples of the ester solvent include methyl acetate, ethyl acetate, and the like. The organic solvents can be used alone or as a mixture of two or more.

A method for forming the surface layer 103 is not particularly limited, and a method generally used can be selected. Examples of the method include coating with a roll coater, dip coating, and ring coating.

After the surface layer 103 is formed, heating can be performed for drying the solvent.

In addition, the surface physical properties such as dynamic friction, surface free energy, etc. can be adjusted by surface treatment of the surface layer 103.

Specifically, a method of irradiation with active energy rays can be used, and ultraviolet light, infrared light, or electron beams can be used as the active energy rays.

The thickness of the surface layer 103 is preferably 0.005 μm to 30 μm and more preferably 0.005 μm to 5 μm.

### (ii) Second Embodiment

The surface layer 103 of the charging member contains a compound represented by formula (b) below and magnesium oxide particles.

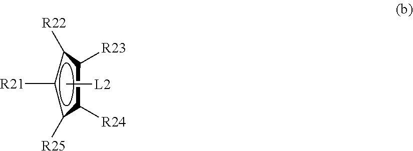

In the formula (b),

L2 represents polymetalloxane having a structural unit represented by M2O_{n/2} wherein M2 represents at least one metal atom selected from the group consisting of Ti, Zr, Hf, V, Nb, Ta, W, Al, Ga, In, and Ge, and
when metal atom M2 has a valence of q, m represents an integer of 1 or more and q or less,
R21 to R25 each independently represent a hydrogen atom, an alkyl group having 1 to 4 carbon atoms, or a trimethylsilyl group, and
a cyclopentadienyl group is coordinated with the metal atom M2 in L2.

In the formula (b), the metal atom M2 in polymetalloxane may include a plurality of metal atoms. Also, polymetalloxane may have a structural unit represented by SiO_{s/2} (s is an integer of 1 or more and 4 or less). Having the structural unit can improve amorphousness of polymetalloxane and further improve smoothness and strength of a film.

In the formula (b), R21 to R25 each independently represent a hydrogen atom, a straight or branched alkyl group having 1 to 4 carbon atoms, or a trimethylsilyl group. In particular, R21 to R25 are each preferably a group showing an electron-donating property. That is, R21 to R25 are preferably each independently a methyl group, a tert-butyl group, or a trimethylsilyl group.

With respect to the formula (b), examples of a compound (hereinafter referred to as a “compound for a ligand”) which is coordinated and bonded to a metal atom to form the above-described structure are shown in Table 5. In the structures shown in Table 5, “Me” represents a methyl group.

TABLE 5

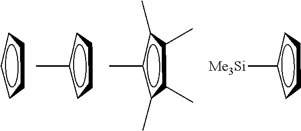

The magnesium oxide particles are the same as described in the first embodiment.

The surface layer 103 according to the second embodiment can be formed by the same method as the surface layer 103 according to the first embodiment.

### (iii) Third Embodiment

The surface layer 103 of the charging member contains

polymetalloxane having a structure represented by formula (c1) below and magnesium oxide particles.
M1 in the polymetalloxane is bonded to a carbon atom in a structural unit represented by structural formula (c2) below through a linking group represented by structural formula (c3).

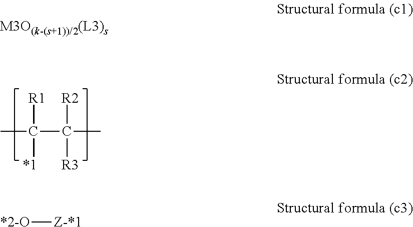

In the formula (c1),

M3 represents any one of metal atoms of Ti, Zr, Hf, V, Nb, Ta, W, Al, Ga, In, and Ge, s represents an integer of 0 or more and k or less,
when M3 is A1, Ga, or In, k=3,
when M3 is Ti, Zr, Hf, or Ge, k=4,
when M3 is Nb, Ta, or W, k=5,
when M3 is V, k=3 or 5, and
L3 represents a ligand having a structure represented by formula (d) below or a ligand having a structure represented by formula (e) below.

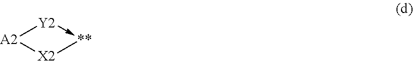

In the formula (d),

X2 represents a structure represented by any one of formulae (5) to (8) below,
Y2 represents a group having a site coordinated with M3,
A2 represents a bond or atomic group necessary for forming a 4- to 8-member ring together with M3, X2, and Y2, and symbol “**” represents a site bonded or coordinated with M3.

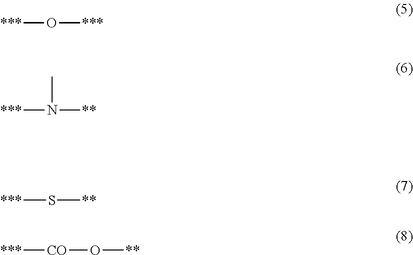

In the formulae (5) to (8), symbol “**” represents a bonding site with M3, and symbol “***” represents a bonding site with A2.

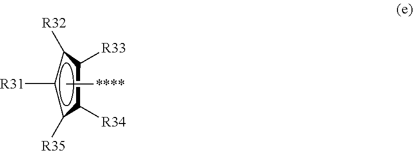

In the formula (e), R31 to R35 each independently represent a hydrogen atom, an alkyl group having 1 to 4 carbon atoms or a trimethylsilyl group, and symbol “****” represents a bonding site with M3.

In the formula (c2), R1 to R3 each independently represent a hydrogen atom or an alkyl group having 1 to 3 carbon atoms, and symbol “*1” represents a bonding site with Z in formula (c3).

In the formula (c3),

Z represents a substituted or unsubstituted phenylene group, and in the case of a substituted phenylene group, a substituent is a halogen atom or an alkyl group having 1 to 3 carbon atoms,
symbol “*1” represents a bonding site with the symbol “*1” in the formula (c2), and
symbol “*2” represents a bonding site with M3 in the formula (c1).

The polymetalloxane according to the embodiment of the present disclosure has a metalloxane structure in which the metal atom M3 is bonded to an oxygen atom. In this case, M3 is any one of titanium (Ti), zirconium (Zr), hafnium (Hf), vanadium (V), niobium (Nb), tantalum (Ta), tungsten (W), aluminum (A1), gallium (Ga), indium (In), and germanium (Ge).

For example, when M3 in the structural formula (c1) is Ti and s=0, the metalloxane structure represented by TiO_{3/2} is present in the polymetalloxane, and Ti in the metalloxane structure is bonded to a carbon atom in the structural unit represented by the structural formula (c2) through a linking group represented by the structural formula (c3). Also, when s=1, the metalloxane structure represented by TiO_{2/2}(L3)₁ is present in the polymetalloxane, and a ligand (d) or (e) described below is coordinated to Ti in the metalloxane structure and is bonded to a carbon atom in the structural unit represented by the structural formula (c2) through a linking group represented by the structural formula (c3).

The polymetalloxane according to the present disclosure may further have a structure represented by structural formula (c4) below. Providing the structure can adjust the properties of the surface layer. Examples of the properties of the surface layer which can be adjusted include smoothness and strength.

M3O_{(k-t)/2}(L3)ₜ Structural formula (c4)

In the structural formula (c4), M1 and k represent the same meanings as M3 and k of the structural formula (c1). In addition, t represents an integer of 0 or more and k−1 or less.

For example, when in the structural formula (c4), M3 is Ti and t=0, the polymetalloxane further contains TiO_{4/2}.

In addition, when t=1, the polymetalloxane further contains TiO_{3/2}(L3)₁.

The presence of the metal atom M3 in the polymetalloxane can be confirmed by, for example, using an energy dispersive X-ray spectrophotometer (EDAX). Also, the presence of the metalloxane structure can be confirmed by, for example, various nuclear magnetic resonance (NMR) analyses. Further, the bond between M3 in the structural formula (c1) and a carbon atom in the structural unit represented by the structural formula (c2) through a linking group represented by the structural formula (c3) can be confirmed by a chemical shift of a peak due to a carbon atom bonded to a hydroxyl group in a phenylene group of polyvinylphenol to the lower magnetic field side in solid-state NMR analysis.

Next, with respect to L1 in the structural formula (c1), a ligand having a structure represented by the formula (d) and a ligand having a structure represented by the formula (e) are described.

In the formula (6), a nitrogen atom may be one in a heterocyclic skeleton such as a substituted or unsubstituted pyrrole skeleton, indole skeleton, pyrolidine skeleton, carbazole skeleton, imidazole skeleton, benzoimidazole skeleton, pyrazole skeleton, indazole skeleton, triazole skeleton, benzotriazole skeleton, tetrazole skeleton, pyrolidone skeleton, piperizine skeleton, morpholine skeleton, or piperazine skeleton. The substituent is, for example, a straight or branched alkyl group or alkoxy group having 1 to 10 carbon atoms, more preferably 1 to 4 carbon atoms. The same is true for substituents described below unless otherwise particularly specified. When the nitrogen atom is not a nitrogen atom in a heterocyclic skeleton, an atom or group bonded to the nitrogen atom other than A2 and M3 is a hydrogen atom, a substituted or unsubstituted aryl group, or an alkyl group having 1 to 10 carbon atoms. Examples thereof include aryl groups such as a phenyl group, a naphthyl group, and the like, straight alkyl groups such as a methyl group, an ethyl group, a n-propyl group, a n-butyl group, a n-hexyl group, a n-octyl group, a n-nonyl group, a n-decyl group, and the like, branched alkyl groups such as an isopropyl group, a tert-butyl group, and the like, and cyclic alkyl groups such as a cyclopentyl group, a cyclohexyl group, and the like. In particular, a group represented by the formula (6) is preferably an unsubstituted amino group, a monoalkylamino group having 1 to 4 carbon atoms, or a group produced by removing a hydrogen atom bonded to a nitrogen atom from a divalent group having a pyrrole skeleton.

In the formula (d), Y2 represents a group having a site coordinated with M3 in the formula (c1) and containing an atom having an unshared electron pair. Examples thereof include a hydroxyl group, an alkoxy group, an aryloxy group, a carbonyl group, a thiol group, an alkylthio group, an arylthio group, a thiocarbonyl group, a substituted or unsubstituted amino group, and a substituted or unsubstituted imino group.

The alkoxy group is, for example, a straight or branched alkoxy group having 1 to 10 carbon atoms. Examples thereof include a methoxy group, an ethoxy group, a n-propoxy group, an isopropoxy group, a n-butoxy group, and a tert-butoxy group. An alkoxy group having 1 to 4 carbon atoms is preferred.

Examples of the arylthio group include substituted or unsubstituted phenoxy group and naphthyloxy group.

An example of the alkylthio group is a group in which an oxygen atom of an alkoxy group is substituted with a sulfur atom.

An example of the arylthio group is a group in which an oxygen atom of an aryloxy group is substituted with a sulfur atom.

Examples of the carbonyl group include a formyl group, an alkylcarbonyl group, an alkoxycarbonyl group, an arylcarbonyl group, a carboxyl group, an amide group (R—CO—NR— or R—NR—CO—), a ureido group (NH₂—CO—NH—), and a urea group (R—NH—CO—NH—). Each of alkyl groups of an alkylcarbonyl group and alkoxycarbonyl group and R in an amide group and a urea group is preferably a hydrogen atom or a straight or branched alkyl group having 1 to 10 carbon atoms. Examples of the alkyl group include straight alkyl groups such as a methyl group, an ethyl group, a n-propyl group, a n-butyl group, a n-hexyl group, a n-octyl group, a n-nonyl group, and a n-decyl group, and branched alkyl groups such as an isopropyl group and a tert-butyl group. An alkyl group having 1 to 4 carbon atoms is more preferred.

The arylcarbonyl group is, for example, a group having a carbonyl group bonded to a substituted or unsubstituted aromatic hydrocarbon or a group having a carbonyl group bonded to a substituted or unsubstituted aromatic heterocycle. Examples thereof include substituted or unsubstituted phenylcarbonyl group and naphthylcarbonyl group.

The thiocarbonyl group is, for example, a group in which an oxygen atom in the carbonyl group is substituted with a sulfur atom.

The substituted amino group is, for example, an alkylamino group, a dialkylamino group, or a substituted or unsubstituted arylamino group. Examples thereof include monoalklylamino groups having 1 to 10 carbon atoms such as a monomethylamino group, a monoethylamino group, and the like, dialkylamino group having 1 to 10 carbon atoms such as a dimethylamino group, a diethylamino group, an methylethylamino group, and the like, and substituted or unsubstituted arylamino groups having 1 to 10 carbon atoms such as a monophenylamino group, a methylphenylamino group, a diphenylamino group, a naphthylamino group, and the like.

The unsubstituted imino group is a group represented by >C═NH or —N═CH₂. A hydrogen atom in the unsubstituted imino group may be substituted with an alkyl group having 1 to 10 carbon atoms or a substituted or unsubstituted aryl group (phenyl group or naphthyl group).

Also, Y2 may be a group having an aliphatic or aromatic heterocyclic skeleton. Examples of an aromatic heterocyclic skeleton include a substituted or unsubstituted thiophene skeleton, furan skeleton, pyridine skeleton, pyran skeleton, benzothiophene skeleton, benzofuran skeleton, quinoline skeleton, isoquinoline skeleton, oxazole skeleton, benzoxazole skeleton, thiazole skeleton, benzothiazole skeleton, thiadiazole skeleton, benzothiadiazole skeleton, pyridazine skeleton, pyrimidine skeleton, pyrazine skeleton, phenazine skeleton, acridine skeleton, xanthene skeleton, imidazole skeleton, benzoimidazole skeleton, pyrazole skeleton, indazole skeleton, triazole skeleton, benzotriazole skeleton, and tetrazole skeleton. Examples of an aliphatic heterocyclic skeleton include a substituted or unsubstituted morpholine skeleton.

Among the groups Y2 described above, Y2 is preferably a hydroxyl group, an alkoxy group having 1 to 4 carbon atoms, a substituted or unsubstituted phenoxy group, a substituted or unsubstituted naphthyloxy group, a formyl group, an alklycarbonyl group containing an alkyl group having 1 to 4 carbon atoms, an alkoxycarbonyl group containing an alkoxy group having 1 to 4 carbon atoms, a thiocarbonyl group, a dimethylamide group, a diethylamide group, an ethylmethylamide group, an unsubstituted amino group, a monomethylamino group, a monoethylamino group, a dimethylamino group, a diethylamino group, a monophenylamino group, a methylethylamino group, a methylphenylamino group, a diphenylamino group, a naphthylamino group, an unsubstituted imino group, a methaneimino group, an ethaneimino group, a group having a pyridine skeleton, a group having a quinoline skeleton, or a group having an isoquinoline skeleton.

A2 in the formula (d) represents a bond or atomic group necessary for forming a 4- to 8-member ring together with M3, X2, and Y2. When A2 is an atomic group necessary for forming a 4- to 8-member ring together with M3, X2, and Y2, examples of the atomic group include atomic groups each containing an alkylene group, such as a methylene group, an ethylene group, a trimethylene group, or a tetramethylene group, an alkenylene group such as a vinylene group, a propenylene group, a butenylene group, or a pentenylene group, and a substituted or unsubstituted aromatic ring (a benzene ring, a naphthalene ring, a pyrrole ring, a thiophene ring, a furan ring, a pyridine ring, a an indole ring, a benzothiophene ring, a benzofuran ring, a quinolone ring, an isoquinoline ring, or the like). In particular, A2 is preferably a bond or an atomic group containing an alkylene group or a substituted or unsubstituted aromatic ring (a benzene ring, a naphthalene ring, a pyrrole ring, a pyridine ring, an indole ring, a quinolone ring, or an isoquinoline ring). In this case, the structure represented by the formula (d) has high stability, and the charging member having the good ability of imparting negative charge can be achieved as compared with the case in which A2 is an alkenylene group.

When A2 is an atomic group containing an aromatic ring, a condensed ring may be formed together with an aromatic heterocyclic ring of Y2, an aromatic heterocyclic ring of X2, or both aromatic heterocyclic rings.

A ring formed by A2, M3, X2, and Y2 is preferably a 5- or 6-member ring from the viewpoint of the ease of formation of a complex.

Preferred examples of a ligand represented by the formula (d) include ligands described below.

When X2 is a ligand represented by the formula (5), a ligand represented by the formula (d) is preferably a structure represented by any one of formulae (9) to (13) below.

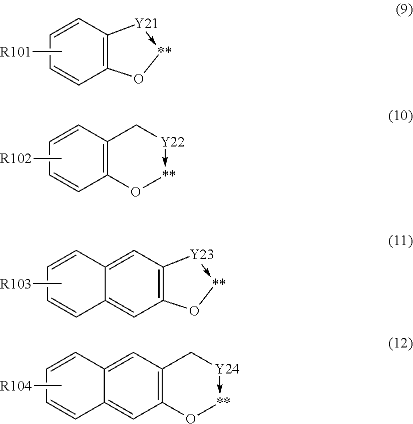

In the formulae (9) to (12), R101 to R104 A1 each independently represent a hydrogen atom, a methoxy group, or an ethoxy group, Y21 to Y24 each independently represent a methoxy group, an ethoxy group, a formyl group, a methylcarbonyl group, an ethylcarbonyl group, a methoxycarbonyl group, an ethoxycarbonyl group, a dimethylamide group, a diethylamide group, a methylethylamide group, a methylthio group, an ethylthio group, a thiocarbonyl group, a dimethylamino group, a diethylamino group, an ethylmethylamino group, an unsubstituted imino group, a methaneimino group, an ethaneimino group, a group having a pyridine skeleton, a group having a quinoline skeleton, or a group having an isoquinoline skeleton, and symbol “**” represents a bonding site with M3.

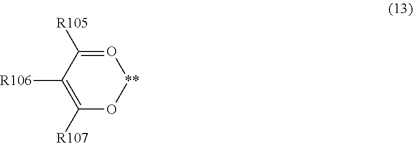

In the formula (13), R105 represents an alkyl group having 1 to 4 carbon atoms, a phenyl group, or a benzyl group, R106 represents a hydrogen atom or an alkyl group having 1 to 4 carbon atoms, R107 represents an alkyl group having 1 to 4 carbon atoms, an alkoxy group having 1 to 4 carbon atoms, a phenyl group, or a benzyl group, and symbol “**” represents a bonding site with M3.

When X2 is a ligand represented by any one of the formulae (6) to (8), a preferred combination of X2, A2, and Y2 in the formula (d) is described blow.

A2 is a bond, a methylene group, an ethylene group, or a trimethylene group, X2 is a structure represented by any one of formulae (6a) to (6c), (7), and (8) below, and Y2 is a methoxy group, an ethoxy group, a formyl group, a methylcarbonyl group, an ethylcarbonyl group, a methoxycarbonyl group, an ethoxycarbonyl group, a dimethylamide group, a diethylamide group, a methylethylamide group, a methylthio group, an ethylthio group, a thiocarbonyl group, a dimethylamino group, a diethylamino group, an ethylmethylamino group, an unsubstituted imino group, a methaneimino group, an ethaneimino group, a group having a pyridine skeleton, a group having a quinoline skeleton, or a group having an isoquinoline skeleton.

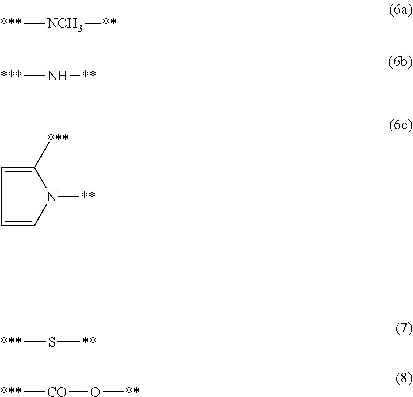

In the formulae (6a) to (6c), (7), and (8), symbol “**” represents a bonding site with M3, and symbol “***” represents a bonding site with A2.

Examples of a compound (hereinafter referred to as a “compound for a ligand”) which can form a ligand having a structure represented by the formula (d) include the same compounds as shown in Tables 1 to 4. Some of the compounds are described in detail below.

When X2 is formula (8), an example of the compound for a ligand is o-anisic acid represented by formula (104) below.

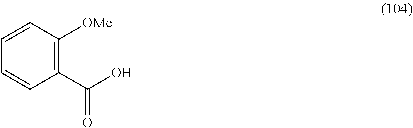 [SMILES: COc1ccccc1C(=O)O]

O-anisic acid forms a complex in which an oxygen atom produced by removal of a hydrogen atom of a carboxyl group is bonded to a metal atom, and an oxygen atom of a methoxy group is coordinated with the metal atom. The residual 1,2-phenylene group corresponds to A2.

When a complex is formed by mixing o-anisic acid and titanium isopropoxide at a molar ratio of 2:1 add mixed with polyvinylphenol, for example, it is considered that a structure represented by formula (105) below can be obtained.

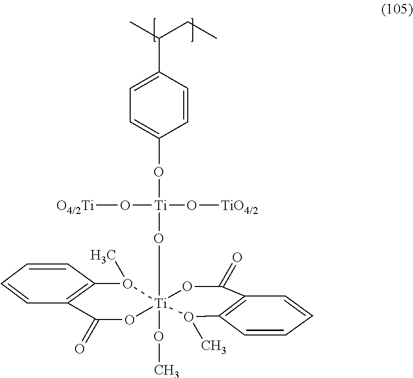

Examples of the compound for a ligand other than the compounds for a ligand shown in Tables 1 to 4 include examples of a compound for a ligand represented by the formula (13).

Examples of a compound for a ligand represented by the formula (13) include β-diketones such as acetylacetone, 3-ethyl-2,4-pentanedione, 3,5-heptanedione, 2,2,6,6-tetramethyl-3, 5-heptanedione, 2,6-dimethyl-3,5-heptanedione, 6-methyl-2,4-heptanedione, 1-phenyl-1,3-butanedione, 3-phenyl-2,4-pentanedione, 1,3-diphenyl-1,3-propanedione, and the like, and β-ketoesters such as methyl aetoacetate, methyl 3-oxopentanoate, methyl 4-oxohexanoate, methyl isobutyrylacetate, methyl 4,4-dimethyl-3-oxovalerate, ethyl acetoacetate, tert-butyl acetoacetate, isopropyl acetoacetate, butyl acetoacetate, benzyl acetoacetate, and the like.

Among these, in acetylacetone represented by formula (106) below, an oxygen atom of a hydroxyl group of an enol form corresponds to X2, a methylcarbonyl group corresponds to Y2, and the residue corresponds to A2.

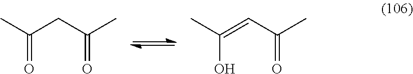

When a complex is formed by mixing acetylacetone and titanium isopropoxide at a molar ratio of 2:1 add mixed with polyvinylphenol, the product is considered to have a structure represented by formula (107) below.

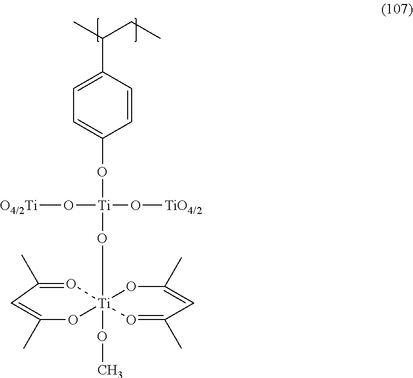

In the formula (e), R31 to R35 are preferably each a group showing an electron donating property. That is, a methyl group, a tert-butyl group, or a trimethylsilyl group is preferred.

In the formula (e), examples of a compound coordinated and bonded to a metal atom to form the structure described above include the same examples as shown in Table 5.

### (Magnesium Oxide Particle)

The magnesium oxide particles are the same as the magnesium oxide particles described in the first embodiment.

### (Method for Forming Surface Layer)

The metalloxane according to the embodiment can be produced by reacting

a polymer having a structural unit containing a phenolic hydroxyl group with
a metal alkoxide having a structure represented by formula (f) below. That is, the metalloxane according to the embodiment can also be defined as a product of reaction between a polymer having a structural unit containing a phenolic hydroxyl group and a metal alkoxide having a structure represented by formula (f) below.

Examples of the polymer having a structural unit containing a phenolic hydroxyl group include a polymer having vinylphenol as a structural unit, such as polyvinylphenol (polyhydroxystyrene), and a novolac-type phenol resin.

The surface layer 103 can be formed by drying a coating film of a coating solution containing the polymer having a structural unit containing a phenolic hydroxyl group and the metal alkoxide having a structure represented by the formula (f) below. That is, the surface layer 103 according to the embodiment contains a product of reaction between the polymer having a structural unit containing a phenolic hydroxyl group and the metal alkoxide having a structure represented by the formula (f) below. The reaction product is amorphous.

M4(OR40)ᵢ₋ⱼ(L4)ⱼ (f)

In the formula (f), M4 represents any one of metal atoms of Ti, Zr, Hf, V, Nb, Ta, W, Al, Ga, In, and Ge. When M4 is A1, Ga, or In, i=3, when M4 is Ti, Zr, Hf, or Ge, i=4, when M4 is Nb, Ta, or W, i=5, and when M4 is V, i=3 or 5.

R40 represents a hydrocarbon group having 1 to 10 carbon atoms.

In addition, j represents an integer of 0 or more and i or less. j is preferably an integer of 1 or more and i or less, and more preferably 1 or 2. The polymetalloxane according to the embodiment obtained by using a metal alkoxide with j=1 or more contains the metal atom M3 to which the ligand (d) or (e) is bonded and coordinated. The polymetalloxane can provide a charging member more excellent in the ability of imparting negative charge to a developer. This is considered to be because the polymetalloxane with j=1 or more is chemically stable as compared with the polymetalloxane with j=0. With j=2 or more, L4 may be different from each other.

R40 is preferably a hydrocarbon group having 1 to 4 carbon atoms.

L4 represents a ligand having a structure represented by formula (g) below or a ligand having a structure represented by formula (h) below.

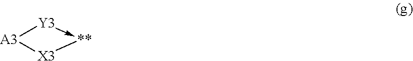

In the formula (g), symbol “**” represents a site bonded or coordinated with M4. A3 and Y3 represent the same meanings as A3 and Y3, respectively, described above. X3 represents a structure represented by any one of formulae (14) to (17) below.

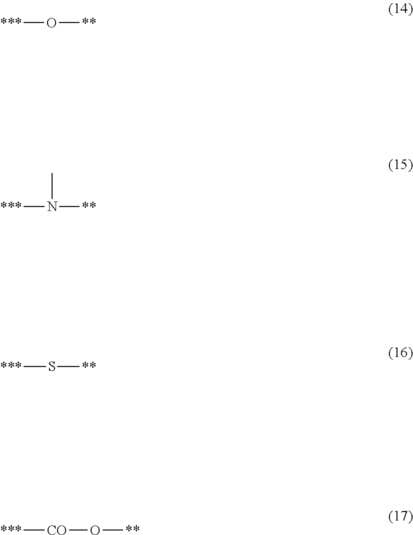

In the formulae (14) to (17), symbol “**” represents a site bonded or coordinated with M4, and symbol “***” represents a bonding site to A3. Specific structures of the formulae (14) to (17) are the same as the formulae (5) to (8), respectively.

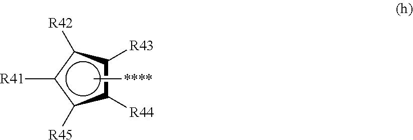

In the formula (h), symbol “****” represents a site bonded or coordinated with M4. R41 to R45 represent the same meanings as R31 to R35, respectively, described above.

The surface layer according to the embodiment can be formed through, for example, Steps (i) to (iii) below.

(i) The step of preparing a coating solution for forming the surface layer.
(ii) The step of forming a coating film of the coating solution.
(iii) The step of drying the coating film.

### (i) Step of Preparing a Coating Solution:

The coating solution can be prepared by, for example, step 1 to step 2 described below.

### <Step 1>

Step 1 is a step of preparing s solution of raw materials constituting the coating solution.

Specifically, a solution (hereinafter, referred to as a “polymer solution”) of a polymer having a structural unit containing a phenolic hydroxyl group is prepared. Also, a solution (hereinafter referred to as a “metal alkoxide solution”) of a compound represented by the formula (f) is prepared.

When a compound with j=1 or more is used as the compound represented by the formula (f), that is, when a compound containing ligand L4 coordinated with the metal atom M4 is used, for example, a solution of a metal alkoxide as a raw material in which the ligand L4 is not coordinated and a solution of a raw material of ligand L4 are prepared, and by mixing the prepared solutions, a solution of a compound related to the formula (f) in which the ligand L4 is coordinated with M4 can be prepared. In this case, the compound for a ligand is preferably added in an amount of 0.5 moles or more, more preferably 1 mole or more, based on 1 mole of metal alkoxide as the raw material. Also, a plurality of compounds or metal alkoxides may be combined. The number of the ligands L4 coordinated per atom of the metal atom M4 is not limited to 1. Also, the number of the types of ligands is not limited to 1, and a plurality of types of ligands may be coordinated with the metal atom M4.

When available, the metal alkoxide with which a compound for a ligand is coordinated can be obtained and directly used.

When a compound with j=0 is used as a compound related to the formula (f), the compound related to the formula (f) agrees with a metal alkoxide as a raw material.

Examples of the metal alkoxide as a raw material in which L4 is not coordinated with M4 include alkoxides of titanium, zirconium, hafnium, vanadium, niobium, tantalum, tungsten, aluminum, gallium, indium, and germanium.

Examples of the alkoxide include alkoxides having 1 to 10 carbon atoms, such as methoxide, ethoxide, n-propoxide, iso-propoxide, n-butoxide, 2-butaoxide, tert-butoxide, and the like. An alkoxide having 1 to 4 carbon atoms is preferred.

### <Step 2>

Step 2 is a step of mixing the polymer solution prepared in Step 1 and the metal alkoxide solution prepared in step 1 to prepare the coating solution.

When the polymer solution and the metal alkoxide solution are mixed in Step 2, the compound represented by the formula (f) is preferably added in an amount of 0.01 moles or more, more preferably 0.1 moles or more, based on the polymer having a structural unit containing a phenolic hydroxyl group.

In order to improve the properties of the surface layer, for example, alkoxysilane may be added to the coating solution for introducing a structure represented by the formula (c4) in the polymetalloxane. When a structure represented by the formula (c4) with t=0 is introduced into the polymetalloxane, examples of the alkoxysilane which can be used include tetraalkoxysilane, trialkoxysilane, and dialkoxysilane.

Examples of the tetraalkoxysilane include tetramethoxysilane, tetraethoxysilane, tetra(n-propoxy)silane, tetra(iso-propoxy)silane, tetra(n-butoxy)silane, tetra(2-butoxy)silane, and tetra(tert-butoxy)silane.

Examples of the trialkoxysilane include trimethoxysilanes and triethoxysilanes.

Examples of the trimethoxysilanes include trimethoxyhydrosilane, trimethoxymethylsilane, trimethoxyethylsilane, trimethoxy(n-propyl)silane, trimethoxy(iso-propoxy)silane, trimethoxy(n-butoxy)silane, trimethoxy(2-butoxy)silane, trimethoxy(tert-butoxy)silane, trimethoxy(n-hexyl)silane, trimethoxy(n-octyl)silane, trimethoxy(n-decyl)silane, trimethoxy(n-dodeca)silane, trimethoxy(n-tetradeca)silane, trimethoxy(n-pentadeca)silane, trimethoxy(n-hexadeca)silane, trimethoxy(n-octadeca)silane, trimethoxycyclohexylsilane, trimethoxyphenylsilane, and trimethoxy(3-glycidylpropyl)silane.

Examples of the triethoxysilanes include triethoxyhydrosilane, triethoxymethylsilane, triethoxyethylsilane, triethoxy(n-propyl)silane, triethoxy(iso-propoxy)silane, triethoxy(n-butoxy)silane, triethoxy(2-butoxy)silane, triethoxy(tert-butoxy)silane, triethoxy(n-hexyl)silane, triethoxy(n-octyl)silane, triethoxy(n-decyl)silane, triethoxy(n-dodeca)silane, triethoxy(n-tetradeca)silane, triethoxy(n-pentadeca)silane, triethoxy(n-hexadeca)silane, triethoxy(n-octadeca)silane, triethoxycyclohexylsilane, triethoxyphenylsilane, and triethoxy(3-glycidylpropyl)silane.

Examples of the dialkoxysilane include dimethoxysilanes and diethoxysilanes.

Examples of dimethoxysilanes include dimethoxydimethylsilane, dimethoxydiethylsilane, dimethoxymethylphenylsilane, dimethoxydiphenylsilane, and dimethoxy(bis-3-glycidylpropyl)silane. Examples of diethoxysilanes include diethoxydimethylsilane, diethoxydiethylsilane, diethoxymethylphenylsilane, diethoxydiphenylsilane, and diethoxy(bis-3-glycidylpropyl)silane.

The organic solvent used is not particularly limited as long as the metal alkoxide and the compound can be dissolved, but an alcohol solvent, an ether solvent, a cellosolve solvent, a ketone solvent, an ester solvent, and the like can be used. Examples of the alcohol solvent include methanol, ethanol, n-propanol, isopropanol, 1-butanol, 2-butanol, tert-butanol, 1-pentanol, and cyclohexanol. Examples of the ether solvent include dimethoxyethane. Examples of the cellosolve solvent include methyl cellosolve and ethyl cellosolve. Examples of the ketone solvent include acetone, methyl ethyl ketone, and methyl iso-butyl ketone. Examples of the ester solvent include methyl acetate, ethyl acetate, and the like. The organic solvents can be used alone or as a mixture of two or more.

### (ii) Step of Forming Coating Film of Coating Solution

The method for forming a coating film of the coating solution prepared above in (i) is not particularly limited, and a method generally used can be selected. Specifically, coating with a roll coater, dip coating, and ring coating can be used.

(iii) Step of Drying Coating Film

The surface layer according to the present disclosure is formed by drying the coating film of the coating solution. The coating film may be dried by heating.

In Step 2 of the step (i) to the step (iii), the compound represented by the formula (f) in the coating solution is subjected to two reactions below.

Reaction takes place to convert an alkoxy group in the compound represented by the formula (f) into a hydroxyl group by hydrolysis and produce a metalloxane bond by condensation of the produced hydroxyl groups.

Reaction takes place to react the metal atom M4 of the compound represented by the formula (f) with a phenolic hydroxyl group of the polymer and bond M2 to the polymer through a linking group represented by the formula (c3).

As a result, the surface layer containing the polymetalloxane according to the present disclosure can be formed.

The hydrolysis of the compound represented by the formula (f) proceeds by a small amount of water contained in the organic solvent used for preparing the coating solution and water in the air taken in the coating solution or the coating film. Also, the degree of hydrolysis and condensation may be controlled by adding water to the coating solution.

The surface of the coating film in the drying step or the surface of the surface layer after drying may be treated for adjusting the surface physical properties of the surface layer, such as friction coefficient, surface free energy, etc. The treatment may be performed by, for example, a method of irradiation with active energy rays. In addition, ultraviolet light, infrared light, or electron beams can be used as the active energy rays, and ultraviolet light is particularly preferably used. The ultraviolet light is preferably applied so that an integral quantity of light is 5,000 J/cm² or more and 10,000 J/cm² or less.

The thickness of the surface layer is preferably 0.005 μm to 30 μm and more preferably 0.005 μm to 5 μm.

The interaction between the polymer having a structural unit containing a phenolic hydroxyl group and the metal alkoxide can be confirmed by performing solid NMR analysis.

### (1) Electrophotographic Image Forming Apparatus and Process Cartridge

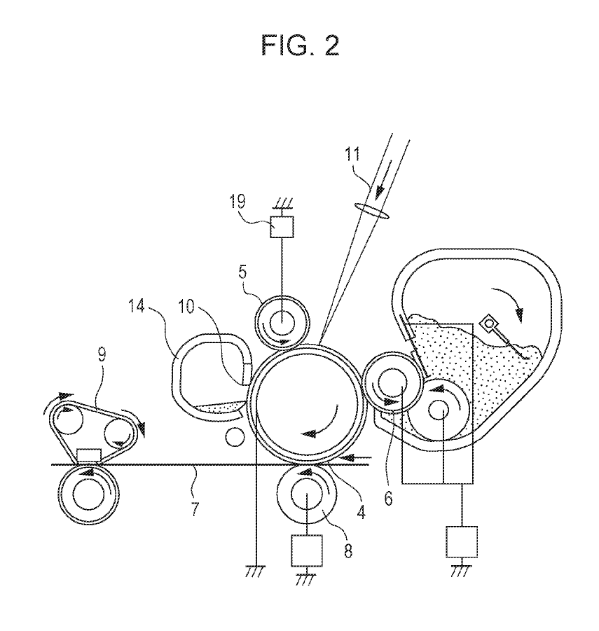

FIG. 2 shows an example of an electrophotographic image forming apparatus including the charging member according to the embodiment of the present disclosure.

A photosensitive member 4 is a rotating drum-shaped image holding member. The photosensitive member 4 is rotationally driven at a predetermined circumferential speed in the clockwise direction shown by an arrow in the drawing.

A charging roller 5 has a roller shape and includes the charging member according to the present disclosure. Specifically, the charging member according to the present disclosure is, for example, any one of the charging members described above in the first to third embodiments.

A charging unit includes a charging bias applying power supply 19 which applies a charging bias to the charging roller 5. The charging roller 5 is brought into contact with the surface of the photosensitive member 4 under predetermined pressure and rotationally driven in the forward direction with respect to the rotation of the photosensitive member 4. When a predetermined direct-current voltage (in examples described below, −1050 V) is applied to the charging roller 5 from the charging bias applying power supply 19 (DC charging system), the surface of the photosensitive member 4 is uniformly charged to a predetermined polar potential (in the examples described below, dark-part potential −500 V).

An exposure unit (not shown) performs image exposure corresponding to intended image information by exposure light 11 on the charged surface of the photosensitive member 4. The potential (in the examples below, light-part potential −150 V) of an exposed light part of the charged surface of the photosensitive member is selectively decreased (attenuated) to form an electrostatic latent image on the photosensitive member 4. A known unit can be used as the exposure unit 11 and, for example, a laser-beam scanner can be used.

A developing roller 6 visualizes the electrostatic latent image as a toner image by selectively depositing a toner (negative toner) charged to the same polarity as the charging polarity of the photosensitive member 4 to the exposed light part of the electrostatic latent image on the surface of the photosensitive member 4. In the examples below, a development bias is −400 V. A development system is not particularly limited and examples thereof include a jumping development system, a contact development system, and a magnetic brush system. In particular, for an electrophotographic image forming apparatus which outputs color images, the contact development system is preferred for the purpose of improving toner scattering.

A transfer roller 8 is brought into contact with the photosensitive member 4 under predetermined pressure and rotated at substantially the same circumferential rotational speed as the photosensitive member 4 in the forward direction with rotation of the photosensitive member 4. Also, a transfer voltage with polarity opposite to the charging polarity of the toner is applied from a transfer bias applying power supply. A transfer material 7 is supplied with predetermined timing to a contact portion between the photosensitive member 4 and the transfer roller 8 from a paper feed mechanism (not shown). The back surface of the transfer material is charged to polarity opposite to the charging polarity of the toner by the transfer roller 8 to which the transfer voltage has been applied. Consequently, the toner image on the photosensitive member side is electrostatically transferred to the surface side of the transfer material 7 in the contact portion between the photosensitive member 4 and the transfer roller 8. A known transfer unit can be used as the transfer roller 8. Specifically, for example, a transfer roller including a conductive metal support coated with an elastic layer whose electroconductivity is controlled in the range of medium resistance, can be used.

The transfer material 7 to which the toner image has been transferred is separated from the surface of the photosensitive member 4, introduced into a fixing device provided with a fixing belt 9, and then output as an image-formed material after fixing of the toner image. In the case of a both-side image forming mode or multiple image forming mode, the image-formed material is introduced into a recycling conveyor mechanism and again introduced into the transfer part. The transfer residual toner on the photosensitive member 4 is recovered from the photosensitive member 4 by a cleaning device 14 having a cleaning blade 10. Also, when residual charge remains on the photosensitive member 4, the residual charge on the photosensitive member 4 may be removed by a pre-exposure device (not shown) after transfer before primary charging by the charging roller 5. In the examples described below, an image was formed without using the pre-exposure device.

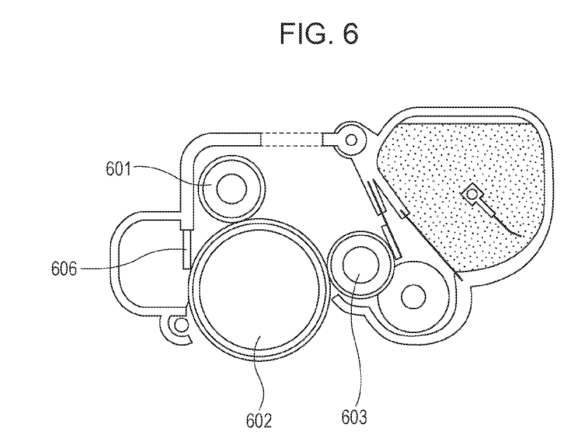

FIG. 6 shows one example of a process cartridge according to the present disclosure. The process cartridge is configured to be detachable from an electrophotographic image forming apparatus body. The process cartridge includes the charging member according to the present disclosure as a charging roller 601, a photosensitive member 602, a developing roller 603, and a cleaning member 606. Each of the examples described below uses a process cartridge comprising the charging roller 601, the photosensitive member 602, the developing roller 603, and the cleaning member 606.

According to an embodiment of the present disclosure, it is possible to provide a charging member which can suppress electrostatic adhesion of a toner to the surface thereof and which exhibits stable charging performance even in long-term use. According to another embodiment of the present disclosure, it is possible to provide a process cartridge and electrophotographic image forming apparatus capable of stably forming an electrophotographic image of high quality.

### EXAMPLES

The present disclosure is described in further detail below by giving examples. However, the present disclosure is not limited to these examples. In the examples, “parts” represents “parts by mass”.

Table 6 shows a list of reagents used in the examples.

TABLE 6

| Symbol | Name | CAS No. | Maker | Remarks |
|---|---|---|---|---|
| S1 | 2-Butanol | 78-92-2 | Kanto Chemical Co., Inc. | Special grade |
| S2 | Ethanol | 64-17-5 | Kishida Chemical Co., Ltd. | Special grade |
| MA1 | Titanium isopropoxide | 546-68-9 | Kishida Chemical Co., Ltd. | |
| MA2 | Pentamethylcyclo- | 123927-75-3 | J & K SCIENTIFIC Ltd., | |
| | pentadienyl titanium | | | |
| | trimethoxide | | | |
| MA3 | Aluminum sec-butoxide | 2269-22-9 | J & K SCIENTIFIC Ltd., | |
| MA4 | Zirconium(IV) propoxide | 2351947-9 | Tokyo Chemical Industry | |
| | | | Co. Ltd. | |
| MA5 | Tungsten(V) ethoxide | 26143-11-3 | Wako Pure Chemical | |
| | | | Industries, Ltd. | |
| CA1 | Silicon tetraethoxide | 78-10-4 | Tokyo Chemical Industry | |
| | | | Co. Ltd, | |
| L1 | Guaiacol | 90-5-1 | Tokyo Chemical Industry | |
| | | | Co, Ltd. | |
| L2 | 2-Acetylpyrrole | 1072-83-9 | Tokyo Chemical Industry | |
| | | | Co, Ltd. | |
| L3 | 2-(Methylthio)phenol | | | |
| L4 | Quinaldic acid | 93-10-7 | Tokyo Chemical Industry | |
| | | | Co. Ltd. | |
| L5 | N,N-dimethylglycine | 1118-68-9 | Tokyo Chemical Industry | |
| | | | Co. Ltd. | |
| P1 | Polyvinylphenol | 24979-70-2 | Sigma-Aldrich Japan K.K. | Weight- |
| | | | | average |
| | | | | molecular |
| | | | | weight |
| | | | | (Mw) |
| | | | | ~25000 |
| MG1 | Magnesium oxide | | Ube Material industries, | 190~240 nm |
| | particle “(vapor phase | | Ltd. | |
| | method) high purity & | | | |
| | ultrafine magnesia | | | |
| | powder 2000A” | | | |

### <Preparation of Coating Solution>

### [Coating Solution E1]

In a glass container of 100 mL, 15.1 g of 2-butanol and 0.74 g of titanium isopropoxide were placed and stirred to prepare a 2-butanol solution of titanium isopropoxide.

In a glass container of 100 mL, 0.32 g of guaiacol and 34.0 g of ethanol were placed and stirred to prepare an ethanol solution of guaiacol.

The prepared ethanol solution of guaiacol was added to the prepared 2-butanol solution of titanium isopropoxide and stirred. Then, 0.22 g of magnesium oxide was added to the resultant mixture and dispersed by a paint shaker to prepare coating solution E1.

### [Coating Solutions E2 to E12]

Coating solutions E2 to E12 were prepared by the same method as in Example 1 except that the compositions of the coating solutions were as shown in Table 7.

TABLE 7

| Coating | | | | | | | Magnesium |
|---|---|---|---|---|---|---|---|
| solution | | | | | | | oxide |
| No. | Metal alkoxide | | Compound for ligand | | 2-Butanol | Ethanol | particle |
| E1 | Titanium | 0.74 g | Guaiacol | 0.32 g | 15.0 g | 34.0 g | 0.32 g |
| | isopropoxide | | | | | | |
| E2 | Titanium | 0.74 g | Guaiacol | 0.32 g | 15.0 g | 34.0 g | 0.64 g |
| | isopropoxide | | | | | | |
| E3 | Titanium | 0.46 g | Guaiacol | 0.40 g | 15.0 g | 34.0 g | 0.26 g |
| | isopropoxide | | | | | | |
| E4 | Titanium | 0.79 g | 2-Acetylpyrrole | 0.30 g | 15.0 g | 34.0 g | 0.33 g |
| | isopropoxide | | | | | | |
| E5 | Titanium | 0.68 g | 2-(Methylthio)phenol | 0.34 g | 15.0 g | 34.0 g | 0.31 g |
| | isopropoxide | | | | | | |
| E6 | Titanium | 0.54 g | Methyl 3-Hydroxy-2- | 0.37 g | 15.0 g | 34.0 g | 0.27 g |
| | isopropoxide | | naphthoate | | | | |
| E7 | Titanium | 0.58 g | Qunaldic acid | 0.35 g | 15.0 g | 34.0 g | 0.28 g |
| | isopropoxide | | | | | | |
| E8 | Titanium | 0.81 g | N,N-dimethylglycine | 0.30 g | 15.0 g | 34.0 g | 0.33 g |
| | isopropoxide | | | | | | |
| E9 | Pentamethyl | 0.67 g | — | — | 15.0 g | 34.0 g | 0.20 g |
| | cyclopentadienyl | | | | | | |
| | titanium | | | | | | |
| | trimethoxide | | | | | | |
| E10 | Aluminum sec- | 0.73 g | Guaiacol | 0.38 g | 15.0 g | 34.0 g | 0.33 g |
| | butoxide | | | | | | |
| E11 | Zirconium(IV) | 0.71 g | Guaiacol | 0.20 g | 15.0 g | 34.0 g | 0.27 g |
| | propoxide | | | | | | |
| E12 | Tungsten(V) | 0.46 g | Guaiacol | 0.28 g | 15.0 g | 34.0 g | 0.22 g |
| | ethoxide | | | | | | |

### [Coating Solution E13]

In a glass container of 100 mL, 15.0 g of 2-butanol and 0.74 g of titanium isopropoxide were placed and stirred to prepare a 2-butanol solution of titanium isopropoxide.

In a glass container of 100 mL, 0.32 g of guaiacol and 34.0 g of ethanol were placed and stirred to prepare an ethanol solution of guaiacol.

The prepared ethanol solution of guaiacol was added to the prepared 2-butanol solution of titanium isopropoxide and stirred for 30 minutes.

To the resultant mixture, 15.0 g of a 1 wt % methyl isobutyl ketone solution of polyvinylphenol (hereinafter, also referred to as a “PVP MIBK solution”) previously prepared was added, followed by stirring for 30 minutes.

Next, 0.22 g of magnesium oxide particles was added to the resultant mixture and dispersed by a paint shaker to prepare coating solution E13.

### [Coating Solutions E14 to E18]

Coating solutions E14 to E18 were prepared by the same method as the coating solution E13 except that the compositions of the coating solutions were as shown in Table 8.

### [Coating Solutions C1 to C3]

Coating solutions C1 to C3 were prepared by the same method as the coating solution E1 except that the compositions of the coating solutions were as shown in Table 8.

TABLE 8

| Coating | | | | | Phenolic hydroxyl | | | | |
|---|---|---|---|---|---|---|---|---|---|
| solution | | | | | group-containing | | | | Magnesium |
| No. | Metal alkoxide | | Compound for ligand | | polymer | | 2-Butanol | Ethanol | oxide particle |
| E13 | Titanium | 0.74 g | Guaiacol | 0.32 g | PVP | 15.0 g | 15.0 g | 34.0 g | 0.48 g |
| | isopropoxide | | | | MIBK | | | | |
| | | | | | solution | | | | |
| E14 | Titanium | 1.00 g | — | — | PVP | 15.0 g | 15.0 g | 34.0 g | 0.46 g |
| | isopropoxide | | | | MIBK | | | | |
| | | | | | solution | | | | |
| E15 | Aluminum sec- | 0.73 g | Guaiacol | 0.38 g | PVP | 15.0 g | 15.0 g | 34.0 g | 0.49 g |
| | butoxide | | | | MIBK | | | | |
| | | | | | solution | | | | |
| E16 | Zirconium(IV) | 0.71 g | Guaiacol | 0.20 g | PVP | 15.0 g | 15.0 g | 34.0 g | 0.43 g |
| | propoxide | | | | MIBK | | | | |
| | | | | | solution | | | | |
| E17 | Tungsten(V) | 0.46 g | Guaiacol | 0.28 g | PVP | 15.0 g | 15.0 g | 34.0 g | 0.38 g |
| | ethoxide | | | | MIBK | | | | |
| | | | | | solution | | | | |
| E18 | Pentamethyl | 0.67 g | — | — | PVP | 15.0 g | 15.0 g | 34.0 g | 0.36 g |
| | Cyclopetadienyl | | | | MIBK | | | | |
| | Titanium | | | | solution | | | | |
| | timethoxide | | | | | | | | |
| C1 | Titanium | 1.00 g | — | — | — | — | 15.0 g | 33.2 g | — |
| | isopropoxide | | | | | | | | |
| C2 | Silicon | 1.00 g | — | — | — | — | 15.0 g | 33.2 g | — |
| | tetraethoxide | | | | | | | | |
| C3 | Silicon | 1.00 g | — | — | — | — | 15.0 g | 33.2 g | 0.30 g |
| | tetraethoxide | | | | | | | | |

### <Structural Analysis 1>

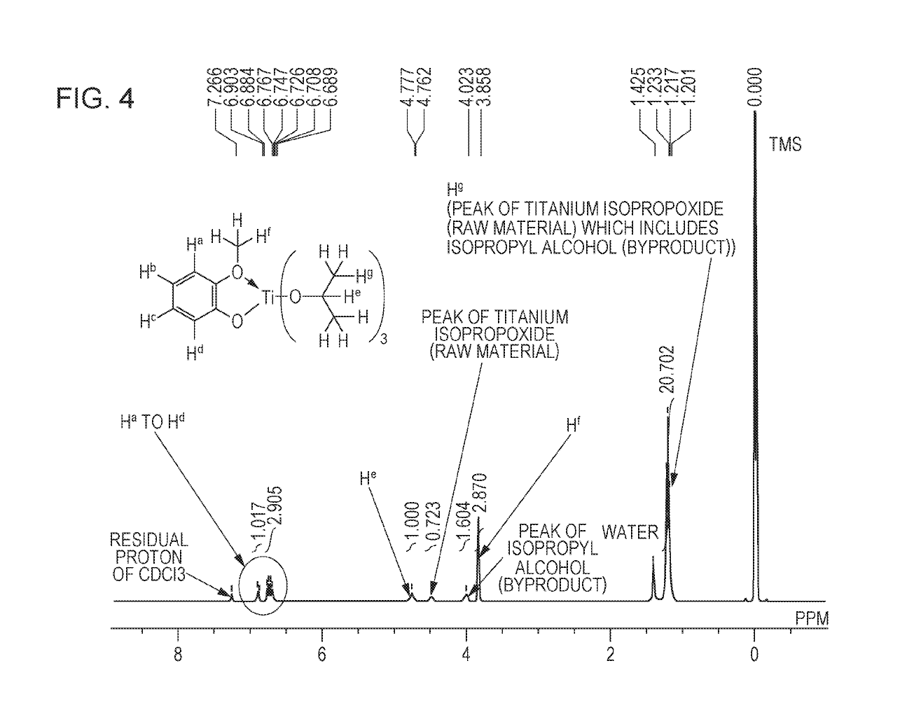

The structure of a compound contained in the coating solution E1 was estimated by a method below. That is, titanium isopropoxide and guaiacol were stirred in deuterochloroform at a temperature of 25° C. and reacted with each other. The structure of the resultant compound was identified by ¹H-NMR. As a result, as shown in FIG. 4, the obtained result suggests having a structure in which guaiacol is coordinated with titanium.

### <Structural Analysis 2>

It was confirmed by NMR that the compound in the coating solution E1 has a titanoxane bond such as TiO_{4/2} or TiO_{3/2}. Specifically, coating solution E1 in which ¹⁷O was introduced by using 17-oxygen labelled water (50 atom %) was separately prepared, and NMR analysis of the coating solution E1 was performed by solution ¹⁷O-NMR measurement using a nuclear magnetic resonance apparatus (trade name: model AVANCE500 NMR; manufactured by Bruker Biospin Corporation). As a result, a peak at 300 to 800 ppm was detected in a ¹⁷O-NMR spectrum. Thus, it was confirmed that the compound contained in the coating solution E1 has a Ti—O—Ti bond.

### <Structural Analysis 3>

The coating solution E1 was dropped on an aluminum sheet degreased with ethanol. Next, a film was formed by rotating the sheet for 2 seconds at 300 rpm. Next, the film was dried for 60 minutes in the environment at room temperature and normal humidity (temperature 23° C., relative humidity 50%) and further dried for 60 minutes at 80° C. in a hot-air circulating oven. The resultant film was separated from the sheet and ground to prepare a sample for measurement.

The sample was observed with SEM (trade name: S-3700N; manufactured by Hitachi High Technologies Co., Ltd.) and elemental analysis was performed by using an EDS apparatus (trade name: Xflash 6/30; manufactured by Bruker Corporation). The elemental analysis was performed in a viewing field with ×300 times magnification at an applied voltage of 20 kV and a probe current of 80 mA. As a result, a K-alpha line peak due to Ti atoms appeared at about 4.5 eV, and thus the presence of Ti atoms was confirmed.

It was estimated from the results of structural analysis 1 to structural analysis 3 described above that the film formed by using the coating solution E1 contains polytitanoxane and has a structure in which guaiacol is coordinated with a titanium atom in the polytitanoxane.

### <Structural Analysis 4>

The same analysis method as in the structural analyses 2 and 3 except using the coating solution E14 confirmed that a compound contained in the coating solution E14 has a titanoxane bond and that a film formed by using the coating solution E14 contains Ti atoms.

### <Structural Analysis 5>

It was estimated by a method below that polyvinylphenol reacts with titanium isopropoxide in the film formed by using the coating solution E14.

The coating solution E14m was prepared by the same method as the coating solution E14 except that magnesium oxide was not added. Then, the coating solution E14m was dropped on an aluminum sheet degreased with ethanol. Next, a film was formed by rotating the sheet for 2 seconds at 300 rpm. Next, the film was dried for 60 minutes in the environment at room temperature and normal humidity (temperature 23° C., relative humidity 50%) and further dried for 60 minutes at 80° C. in a hot-air circulating oven. The resultant film was separated from the sheet and ground to prepare a sample for measurement.

NMR analysis of the sample was performed by solid-state NMR (¹³C-CPMAS method) measurement using a nuclear magnetic resonance apparatus (trade name; NMR Spectrometer ECX 50011; manufactured by JOEL RESONANCE Inc.). The measurement was performed by using a sample tube with an outer diameter or 3.2 mm and conditions of a MAS speed of 15 kHz and an accumulative number of 256.

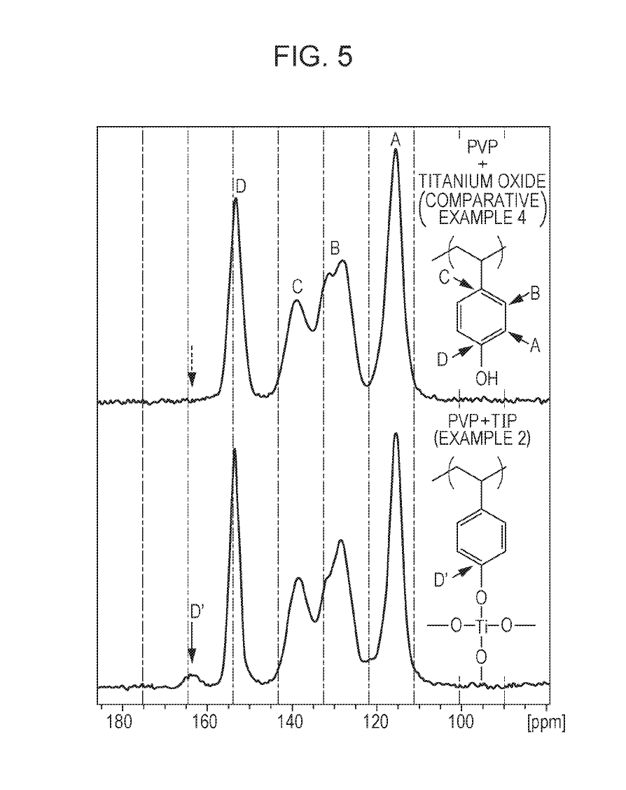

The measurement results are shown in FIG. 5. A peak D′ not present in the starting material appears with the sample prepared by using the coating solution E14m. This is estimated to be because a peak D of a carbon atom bonded to a hydroxyl group in polyvinylphenol is shifted by reaction of the hydroxyl group with titanium isopropoxide.

It was estimated from the results of structural analysis 4 that the film formed by using the coating solution E14 contains polymetalloxane containing Ti atoms and having a titanoxane bond. That is, it was estimated that the film contains polytitanoxane.

It was estimated from the results of structural analysis 5 that a titanium atom bonded to a hydroxyl group of polyvinylphenol is present in the polytitanoxane formed from the coating solution E14, that is, the polytitanoxane has a structure in which a titanium atom is bonded to polyvinylphenol through the structural formula (c3).

### Example 1

### Formation of Charging Roller

The materials shown in Table 9 were mixed by a 6 L kneader (apparatus used: trade name, TD6-15MDX manufactured by Toshin Co., Ltd.) at a filling rate of 70 vol % and a blade rotational speed of 30 rpm for 24 minutes to produce an unvulcanized rubber composition. Then, 4.5 parts of tetrabenzylthiuram disulfide [trade name: Sanceler TBZTD, manufactured by Sanshin Chemical Industry Co., Ltd.] serving as a vulcanization accelerator and 1.2 parts of sulfur as a vulcanization agent were added to 174 parts of the unvulcanized rubber composition. Cutting back to right and left was performed 20 times by using an open roll having a roll diameter of 30.5 cm (12 inches) at a front roll rotational speed of 8 rpm, a rear roll rotational speed of 10 rpm, and a roll gap of 2 mm. Then, the mixture was passed 10 times through a roll gap of 0.5 mm to produce a kneaded material I for an elastic layer.

TABLE 9

| | Use |
|---|---|
| Raw material | amount |
| Medium-high nitrile NBR | 100 |
| (trade name: Nipol DN219, bonded acrylonitrile content | parts |
| center value: 33.5%, Mooney viscosity center value 27, | |
| manufactured by Zeon Corporation) | |
| Carbon black for color (filler) | 48 parts |
| (trade name: #7360SB, particle diameter 28 nm, nitrogen | |
| adsorption specific surface area 77 m2/g, DBP absorption | |
| amount 87100 cm 3/100g, manufacture by Tokai Carbon | |
| Co., Ltd.) | |
| Calcium carbonate (filler) | 20 parts |
| (trade name: Nanox #30 manufactured by Maruo Calcium | |
| Co., Ltd.) | |
| Zinc oxide | 5 parts |
| (trade name: zinc oxide type 2, manufactured by Sakai | |
| Chemical Industry Co., Ltd.) | |
| Zinc stearate | 1 part |
| (trade name: zinc stearate, manufactured by NOF | |
| Corporation) | |

Next, a cylindrical steel-made support (with the surface plated with nickel) having a diameter of 6 mm and a length of 252 mm was prepared. Then, a thermosetting adhesive (trade name: Metaloc U-20, manufactured by Toyo Kagaku Kenkyusho Co., Ltd.) containing a metal and rubber was applied to the support in a region (region with a width of 232 mm in total in the axial direction) of 115.5 mm to both sides from the center in the axial direction. Then, the support was dried at a temperature of 80° C. for 30 minutes and further dried at a temperature of 120° C. for 1 hour to produce a core with an adhesive layer.

The kneaded material I and the core with an adhesive layer used as a center were simultaneously coaxially extruded, by extrusion molding, into a cylinder having an outer diameter of 8.75 to 8.90 mm. The end portions were cut to form an elastic roller including an unvulcanized elastic layer laminated on the outer periphery of the core.

Next, the elastic roller including the unvulcanized elastic layer laminated thereon was vulcanized by heating at 80° C. for 30 minutes and then at 160° C. for 30 minutes to produce the vulcanized elastic roller.

Next, both ends portions of the elastic layer of the vulcanized elastic roller were cut to form an elastic layer having a width of 232 mm in the axial direction. Then, the surface of the elastic layer was polished by a rotary grindstone. As a result, a crown-shaped elastic roller (elastic roller after surface polishing) was produced, in which the diameter at the ends was 8.26 mm and the diameter of a central portion was 8.50 mm.

Next, the coating solution E1 was applied to the elastic layer of the elastic roller after surface polishing by ring coating (total discharge amount: 0.100 ml, ring part speed: 85 mm/s). The coating film was cured by irradiating the surface of the coating film of the coating solution E1 with ultraviolet light at a wavelength of 254 nm so that an integral light quantity was 9000 mJ/cm², thereby forming a surface layer. Ultraviolet irradiation was performed by using a low-pressure mercury lamp (manufactured by Harison Toshiba Lighting Corporation). A charging roller E1 was produced as described above.

### [Evaluation (1) Measurement of Charging Polarity of Coating Film of Coating Solution]

The coating solution E1 was applied on a SUS plate by a spin coater and then dried. Next, the surface of the coating film of the coating solution E1 was irradiated with ultraviolet light at a wavelength of 254 nm so that an integral light quantity was 9000 mJ/cm², thereby forming a sample plate having a film with a thickness of about 300 nm.

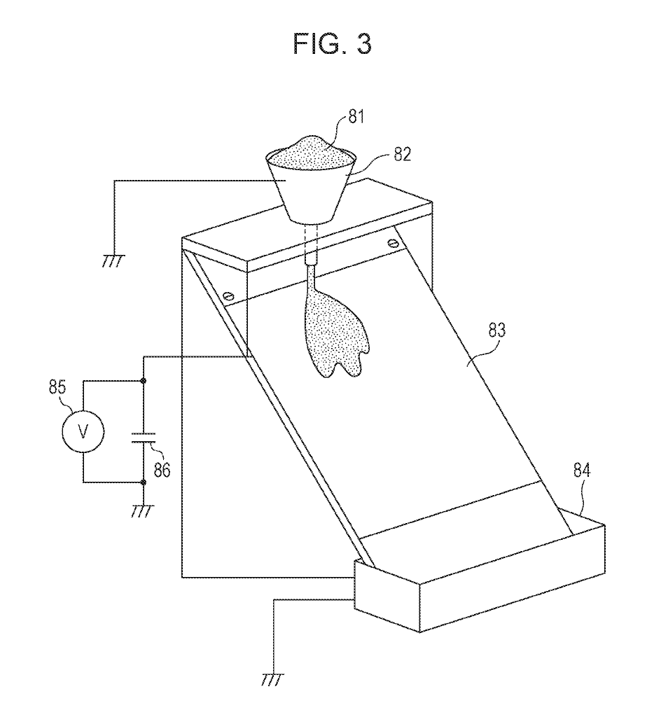

Then, the sample plate was set as a sample plate 83 of a surface charge quantity measuring device TS-100AS (manufactured by Toshiba Chemical Co., Ltd.) shown in FIG. 3. A potentiometer 85 was set to a value of 0 by grounding. The sample plate 83 was allowed in a grounded state over night or more in the environment of 23° C. and 60% RH. Also, a standard carrier N-01 of the Imaging Society of Japan was used as carrier particles 81 and allowed in a grounded state over night or more in the environment of 23° C. and 60% RH.

Then, the carrier particles 81 were placed in a dropper 82 and a start switch was pushed to drop the carrier particles 81 on the sample plate 83 for 20 seconds. The carrier particles 81 were received by a receptor 84 previously grounded. At this time, charge amount Q (μC) shown by the potentiometer 85 was read. The measurement was performed in the environment of 23° C. and 60% RH. In FIG. 3, reference numeral 86 denotes a capacitor.

The charge amount Q/M (μC/g) of the carrier particles per unit mass was calculated from the measured charge amount Q (μC) and the mass M (g) of the captured carrier particles.

The higher the Q/M value is, the more easily the negatively chargeable toner is negatively charged by friction with the coating film of the coating solution. Therefore, it is considered that a charging member having a surface layer formed by using a coating solution exhibiting a high value of charge amount Q/M calculated by the evaluation method has the effect of suppressing electrostatic adhesion of weak negatively chargeable or positively chargeable toner to the charging member. The results are shown in Table 9.

### [Evaluation (2) Evaluation of Amount of Stain Adhering to Charging Roller]

An image was evaluated as described below by using the formed charging roller E1.

A laser beam printer (Satera LBP3100, manufactured by Canon Kabushiki Kaisha) was prepared as an image evaluating machine. The laser beam printer was modified by removing a photosensitive member cleaning member from a process cartridge of the laser beam printer so that the charging member was rotated at a circumferential speed of 120% of the photosensitive member.

The charging roller E1 was incorporated into the process cartridge, and the process cartridge was mounted in the electrophotographic image forming apparatus.

Then, 3,000 electrophotographic images with a pint density of 1% were formed in the environment of 10° C. and 15% RH.

An amount of toner adhesion was evaluated as follow. The toner adhering to the surface of the charging roller was removed by using a cellophane tape which was then attached to white paper. On the other hand, a cellophane tape without toner adhesion was attached to the same white paper. Then, the reflection density of each of the cellophane tape with toner adhesion and the cellophane tape without toner adhesion was measured by using a photovolt reflection densitometer (trade name: TC-6DS/A, manufactured by Tokyo Denshoku Co., Ltd.), and an amount of toner adhesion was quantified from formula (22) below.

Adhesion amount (%)={(Refection density of portion without toner adhesion)−(Refection density of portion with toner adhesion)}/(Refection density of portion without toner adhesion) Formula (22)

The obtained values were evaluated based on the following evaluation criteria. The results are shown in Table 9.

Rank “A”: less than 10%
Rank “B”: 10% or more and less than 30%
Rank “C”: 30% or more and less than 60%
Rank “D”: 60% or more

### Examples 2 to 18 and Comparative Examples 1 to 3

Charging rollers E2 to E18 were formed and evaluated by the same method as in Example 1 except that the coating solution E1 was changed to the coating solutions E2 to E18, respectively.

Also, charging rollers C1 to C3 were formed and evaluated by the same method as in Example 1 except that the coating solution E1 was changed to the coating solutions C1 to C3, respectively.

The evaluation results are summarized in Table 10.

TABLE 10

| | Evaluation 1 | | Evaluation 2 | |
|---|---|---|---|---|
| | Coating solution | Q/M | Charging roller | |
| | No. | (×10⁻³) | No. | Rank |
| Example 1 | E1 | 1.5 | E1 | A |
| Example 2 | E2 | 2.0 | E2 | A |
| Example 3 | E3 | 1.4 | E3 | A |
| Example 4 | E4 | 1.1 | E4 | A |
| Example 5 | E5 | 1.1 | E5 | A |
| Example 6 | E6 | 0.8 | E6 | A |
| Example 7 | E7 | 0.6 | E7 | B |
| Example 8 | E8 | 0.5 | E8 | B |
| Example 9 | E9 | 0.3 | E9 | C |
| Example 10 | E10 | 3.2 | E10 | A |
| Example 11 | E11 | 2.8 | E11 | A |
| Example 12 | E12 | 1.0 | E12 | A |
| Example 13 | E13 | 0.3 | E13 | B |
| Example 14 | E14 | 0.3 | E14 | C |
| Example 15 | El5 | 0.8 | E15 | B |
| Example 16 | El6 | 0.2 | E16 | C |
| Example 17 | E17 | 0.1 | E17 | C |
| Example 18 | E18 | 0.1 | E18 | C |
| Comparative | C1 | −1.4 | C1 | D |
| Example 1 | | | | |
| Comparative | C2 | −6.5 | C2 | D |
| Example 2 | | | | |
| Comparative | C3 | −2.7 | C3 | D |
| Example 1 | | | | |

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2015-081142, filed Apr. 10, 2015, which is hereby incorporated by reference herein in its entirety.

What is claimed is:

1. A charging member comprising:
a support; and
a surface layer on the support,
wherein the surface layer contains
a magnesium oxide particle; and
a compound represented by a following formula (a) or a compound represented by a following formula (b): 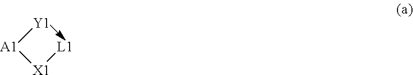
(in the formula (a),
L1 represents polymetalloxane having a structural unit represented by M1O_{n/2} wherein when metal atom M1 has a valence of p, n represents an integer of 1 or more and p or less,
M1 represents at least one metal atom selected from the group consisting of Ti, Zr, Hf, V, Nb, Ta, W, Al, Ga, In, and Ge,
X1 represents a structure represented by any one of following formulae (1) to (4),
Y1 represents a group having a site coordinated with M1 in L1, and
(i) when X1 is a structure represented by the formula (1), A1 represents an atomic group necessary for forming a 4 to 8 member ring together with M1, X1, and Y1, and containing an aromatic ring in which one carbon atom constituting the aromatic ring is bonded to an oxygen atom of X1, and
(ii) when X1 is a structure represented by any one of the formulae (2) to (4),
A1 represents a bond or atomic group necessary for forming a 4 to 8 member ring together with M1, X1, and Y1: 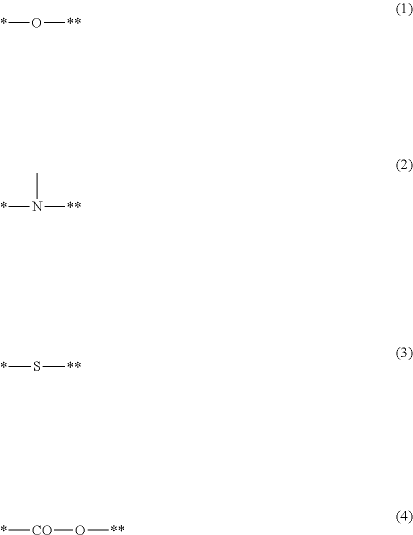
in the formulae (1) to (4), symbol “*” represents a bonding site with A1, and symbol “**” represents a bonding site with M1 in L1, 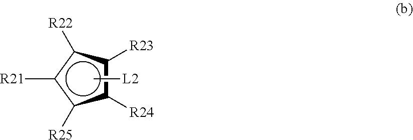
in the formula (b),
L2 represents polymetalloxane having a structural unit represented by M2O_{m/2} wherein M2 represents at least one metal atom selected from the group consisting of Ti, Zr, Hf, V, Nb, Ta, W, Al, Ga, In, and Ge, and
when metal atom M2 has a valence of q, m represents an integer of 1 or more and q or less,
R21 to R25 each independently represent a hydrogen atom, an alkyl group having 1 to 4 carbon atoms, or a trimethylsilyl group, and
a cyclopentadienyl group is coordinated with the metal atom M2 in L2.

2. The charging member according to claim 1, wherein in the formula (a), Y1 is a hydroxyl group, an alkoxy group, a substituted or unsubstituted aryloxy group, a carbonyl group, an alkylthio group, a substituted or unsubstituted arylthio group, a thiocarbonyl group, a substituted or unsubstituted amino group, a substituted or unsubstituted imino group, a group having a substituted or unsubstituted aliphatic heterocyclic skeleton, or a group having a substituted or unsubstituted aromatic heterocyclic skeleton.

3. The charging member according to claim 1, wherein when X1 in the formula (a) is a structure represented by the formula (1), A1 is an atomic group containing an aromatic ring selected from the group consisting of substituted or unsubstituted benzene ring, substituted or unsubstituted naphthalene ring, substituted or unsubstituted pyrrole ring, substituted or unsubstituted thiophene ring, substituted or unsubstituted furan ring, substituted or unsubstituted pyridine ring, substituted or unsubstituted indole ring, substituted or unsubstituted benzothiophene ring, substituted or unsubstituted benzofuran ring, substituted or unsubstituted quinoline ring, and substituted or unsubstituted isoquinoline ring.

4. The charging member according to claim 1, wherein when X1 in the formula (a) is a structure represented by any one of the formulae (2) to (4), A1 is
a bond,
an alkylene group,
or
an atomic group containing an aromatic ring selected from the group consisting of substituted or unsubstituted benzene ring, substituted or unsubstituted naphthalene ring, substituted or unsubstituted pyrrole ring, substituted or unsubstituted thiophene ring, substituted or unsubstituted furan ring, substituted or unsubstituted pyridine ring, substituted or unsubstituted indole ring, substituted or unsubstituted benzothiophene ring, substituted or unsubstituted benzofuran ring, substituted or unsubstituted quinoline ring, and substituted or unsubstituted isoquinoline ring.

5. The charging member according to claim 1, wherein in the formula (a),
a ring formed by A1, M1, X1, and Y1 is a 5-member ring or a 6-member ring.

6. The charging member according to claim 1, wherein the polymetalloxane has a structural unit represented by SiO_{r/2} (r is an integer of 1 or more and 4 or less).

7. A charging member comprising:
a support; and
a surface layer on the support,
wherein the surface layer contains
a magnesium oxide particle; and
a polymetalloxane having a structure represented by structural formula (c1) below, and wherein
in the polymetalloxane, M3 is bonded to a carbon atom in a structural unit represented by a following structural formula (c2) with a linking group represented by a following structural formula (c3):
M3O_{(k-(s+1))/2}(L3)ₛ Structural formula (c1) 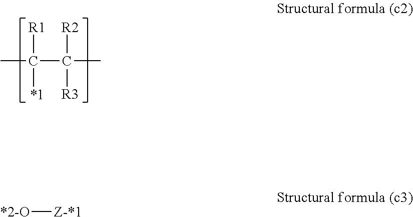
in the formula (c1),
M3 represents any one of metal atoms of Ti, Zr, Hf, V, Nb, Ta, W, Al, Ga, In, and Ge, s represents an integer of 0 or more and k or less,
when M3 is A1, Ga, or In, k=3,
when M3 is Ti, Zr, Hf, or Ge, k=4,
when M3 is Nb, Ta, or W, k=5,
when M3 is V, k=3 or 5, and
L3 represents a ligand having a structure represented by a following formula (d) or a ligand having a structure represented by a following formula (e): 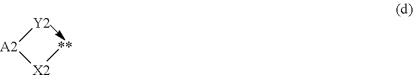
in the formula (d),
X2 represents a structure represented by any one of a following formulae (5) to (8),
Y2 represents a group having a site coordinated with M3,
A2 represents a bond or atomic group necessary for forming a 4 to 8 member ring together with M3, X2, and Y2, and symbol “**” represents a site bonded or coordinated with M3, 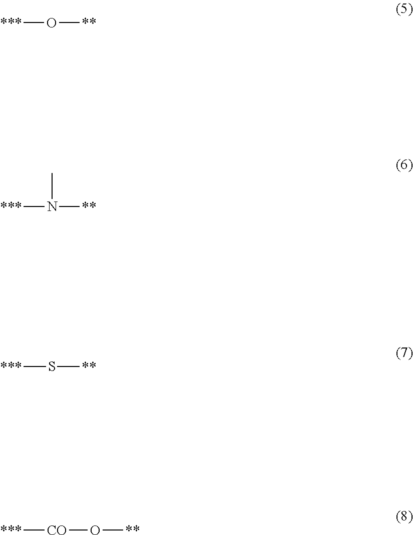
in the formulae (5) to (8), symbol “**” represents a bonding site with M3, and symbol “***” represents a bonding site with A2; 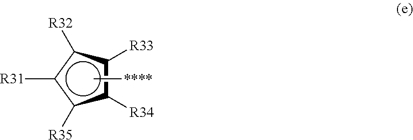
in the formula (e), R31 to R35 each independently represent a hydrogen atom, an alkyl group having 1 to 4 carbon atoms, or a trimethylsilyl group, and symbol “****” represents a bonding site with M3;
in the formula (c2), R1 to R3 each independently represent a hydrogen atom or an alkyl group having 1 to 3 carbon atoms, and symbol “*1” represents a bonding site with Z in formula (c3),
in the formula (c3),
Z represents a substituted or unsubstituted phenylene group, and in a substituted phenylene group, a substituent is a halogen atom or an alkyl group having 1 to 3 carbon atoms, symbol “*1” represents a bonding site with the symbol “*1” in the formula (c2), and
symbol “*2” represents a bonding site with M3 in the formula (c1).

8. The charging member according to claim 7, wherein A2 is a bond, an alkylene group, or an atomic group containing an aromatic ring selected from the group consisting of substituted or unsubstituted benzene ring, substituted or unsubstituted naphthalene ring, substituted or unsubstituted pyrrole ring, substituted or unsubstituted thiophene ring, substituted or unsubstituted furan ring, substituted or unsubstituted pyridine ring, substituted or unsubstituted indole ring, substituted or unsubstituted benzothiophene ring, substituted or unsubstituted benzofuran ring, substituted or unsubstituted quinoline ring, and substituted or unsubstituted isoquinoline ring.

9. The charging member according to claim 7, wherein Y2 is a hydroxyl group, an alkoxy group, a substituted or unsubstituted aryloxy group, a carbonyl group, an alkylthio group, a substituted or unsubstituted arylthio group, a thiocarbonyl group, a substituted or unsubstituted amino group, a substituted or unsubstituted imino group, a group having a substituted or unsubstituted aliphatic heterocyclic skeleton, or a group having a substituted or unsubstituted aromatic heterocyclic skeleton.

10. The charging member according to claim 7, wherein a ring formed by A2, M3, X2, and Y2 is a 5 member ring or a 6 member ring.

11. The charging member according to claim 7, wherein the polymer having a structural unit containing a phenolic hydroxyl group is a polymer having vinylphenol as a structural unit or a novolac-type phenol resin.

12. A process cartridge detachable from an electrophotographic image forming apparatus body, the process cartridge comprising:
an electrophotographic photosensitive member; and
a charging member which charges the surface of the electrophotographic photosensitive member, both members being integrally supported,
wherein the charging member comprises a support, and a surface layer on the support,
the surface layer containing:
a magnesium oxide particle; and
a compound represented by a following formula (a) or a compound represented by a following formula (b): 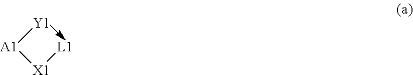
(in the formula (a),
L1 represents polymetalloxane having a structural unit represented by M1O_{n/2} wherein when metal atom M1 has a valence of p, n represents an integer of 1 or more and p or less,
M1 represents at least one metal atom selected from the group consisting of Ti, Zr, Hf, V, Nb, Ta, W, Al, Ga, In, and Ge,
X1 represents a structure represented by any one of following formulae (1) to (4),
Y1 represents a group having a site coordinated with M1 in L1, and
(i) when X1 is a structure represented by the formula (1), A1 represents an atomic group necessary for forming a 4 to 8 member ring together with M1, X1, and Y1, and containing an aromatic ring in which one carbon atom constituting the aromatic ring is bonded to an oxygen atom of X1, and
(ii) when X1 is a structure represented by any one of the formulae (2) to (4), A1 represents a bond or atomic group necessary for forming a 4 to 8 member ring together with M1, X1, and Y1: 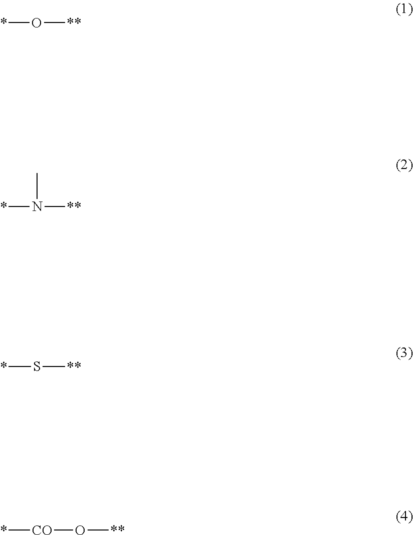
in the formulae (1) to (4), symbol “*” represents a bonding site with A1, and symbol “**” represents a bonding site with M1 in L1, 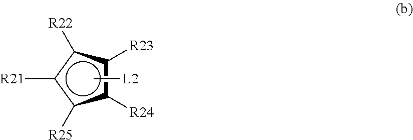
in the formula (b),
L2 represents polymetalloxane having a structural unit represented by M2O_{m/2} wherein M2 represents at least one metal atom selected from the group consisting of Ti, Zr, Hf, V, Nb, Ta, W, Al, Ga, In, and Ge, and
when metal atom M2 has a valence of q, m represents an integer of 1 or more and q or less,
R21 to R25 each independently represent a hydrogen atom, an alkyl group having 1 to 4 carbon atoms, or a trimethylsilyl group, and
a cyclopentadienyl group is coordinated with the metal atom M2 in L2.

13. An electrophotographic image forming apparatus comprising:
an electrophotographic photosensitive member; and
a charging member which charges the surface of the electrophotographic photosensitive member,
wherein the charging member comprises a support, and a surface layer on the support,
the surface layer containing:
a magnesium oxide particle; and
a compound represented by a following formula (a) or a compound represented by a following formula (b): 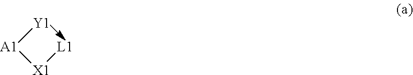
(in the formula (a),
L1 represents polymetalloxane having a structural unit represented by M1O_{n/2} wherein when metal atom M1 has a valence of p, n represents an integer of 1 or more and p or less,
M1 represents at least one metal atom selected from the group consisting of Ti, Zr, Hf, V, Nb, Ta, W, Al, Ga, In, and Ge,
X1 represents a structure represented by any one of following formulae (1) to (4),
Y1 represents a group having a site coordinated with M1 in L1, and
(i) when X1 is a structure represented by the formula (1), A1 represents an atomic group necessary for forming a 4 to 8 member ring together with M1, X1, and Y1, and containing an aromatic ring in which one carbon atom constituting the aromatic ring is bonded to an oxygen atom of X1, and
(ii) when X1 is a structure represented by any one of the formulae (2) to (4), A1 represents a bond or atomic group necessary for forming a 4 to 8 member ring together with M1, X1, and Y1: 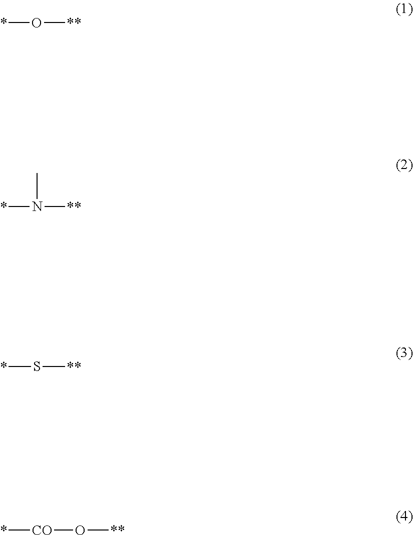
in the formulae (1) to (4), symbol “*” represents a bonding site with A1, and symbol “**” represents a bonding site with M1 in L1, 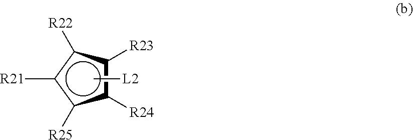
in the formula (b),
L2 represents polymetalloxane having a structural unit represented by M2O_{m/2} wherein M2 represents at least one metal atom selected from the group consisting of Ti, Zr, Hf, V, Nb, Ta, W, Al, Ga, In, and Ge, and
when metal atom M2 has a valence of q, m represents an integer of 1 or more and q or less,
R21 to R25 each independently represent a hydrogen atom, an alkyl group having 1 to 4 carbon atoms, or a trimethylsilyl group, and
a cyclopentadienyl group is coordinated with the metal atom M2 in L2.
